(19) United States
(12) Patent Application Publication
(10) Pub. No.: US 2014/0007688 A1
(43) Pub. Date: Jan. 9, 2014

(54) ACOUSTO-OPTIC IMAGING SYSTEM, AND ACOUSTO-OPTIC IMAGING APPARATUS

(71) Applicant: Panasonic Corporation, Osaka (JP)

(72) Inventors: Ushio SANGAWA, Nara (JP); Takuya IWAMOTO, Osaka (JP); Yuriko KANEKO, Nara (JP); Masahiko HASHIMOTO, Osaka (JP)

(73) Assignee: Panasonic Corporation, Osaka (JP)

(21) Appl. No.: 14/026,585

(22) Filed: Sep. 13, 2013

Related U.S. Application Data
(63) Continuation of application No. PCT/JP2012/003754, filed on Jun. 8, 2012.

(30) Foreign Application Priority Data
Jun. 17, 2011 (JP) 2011-135259

(51) Int. Cl. G01N 29/04

(52) U.S. Cl. CPC G01N 29/04
USPC 73/606

(57) ABSTRACT

An acousto-optic imaging system includes: an ultrasonic wave source for irradiating an imaged object with an ultrasonic wave; an acoustic lens for converting a scattered wave of the ultrasonic wave to a plane wave; a light-transmitting acoustic medium provided in an area on an opposite side of the imaged object with respect to the acoustic lens; a light source for outputting a monochromatic light plane wave; an image-forming lens arranged so as to condense diffraction light of the monochromatic light plane wave which is produced in the light-transmitting acoustic medium; an image-receiving section for obtaining an optical image formed by the image-forming lens; and a distortion compensation section for correcting a distortion of the optical image or a distortion.

This is a continuation of International Application No. PCT/JP2012/003754, with an international filing date of Jun. 8, 2012, which claims priority of Japanese Patent Application No. 2011-135259, filed on Jun. 17, 2011, the contents of which are hereby incorporated by reference.

### BACKGROUND

1. Technical Field

The present application relates to an acousto-optic imaging system, in which an imaged object is irradiated with an ultrasonic wave and the ultrasonic wave scattered by the imaged object is introduced into an acousto-optic medium, thus forming a refractive index distribution across the acousto-optic medium, thereby causing Bragg diffraction, which is used to map the intensity/phase distribution of the scattered ultrasonic wave onto an intensity/phase distribution of monochromatic light, thus obtaining an ultrasonic image as an optical image.

2. Description of the Related Art

Ultrasonographs are known in the art as an apparatus for irradiating an imaged object with an ultrasonic wave so as to generate an optical image from the scattered wave from the imaged object. For example, Japanese Laid-Open Patent Publication No. 54-34580 (hereinafter, referred to as Patent Document No. 1) discloses an example of an ultrasonograph.

FIG. 13 is a diagram showing the imaging principle of the ultrasonograph described in Patent Document No. 1. The ultrasonograph shown in FIG. 13 includes rectangular transducers T1 to T15 of the same shape and the same characteristics. The rectangular transducers T1 to T15 are configured to be able to transmit/receive ultrasonic waves through vibration. In the example shown in FIG. 13, the rectangular transducers T1 to T15 are arranged in one-dimensional pattern.

When one of the rectangular transducers T1 to T15 receives an ultrasonic wave, the rectangular transducer outputs a receive signal. These receive signals are synthesized together in delay synthesis by a signal processing circuit (not shown).

Delay synthesis generates a synthesized signal S=A1×S1(t+t1)+A2×S2(t+t2)+ . . . +A15×S15(t+t15) where Si(t) (i=1, . . . , 15) denotes the receive signal output from the rectangular transducer Ti (i=1, . . . , 15). Herein, t represents the time, ti (i=1, . . . , 15) represents the time shift (delay time), and Ai (i=1, . . . , 15) represents the weight. Delay synthesis is a signal synthesis method for adding together receive signals output from rectangular transducers while shifting the time and giving an appropriate weight to each receive signal.

The ultrasonograph shown in FIG. 13 is capable of obtaining an ultrasonic image of an imaged object. Hereinafter, the imaging principle for an ultrasonic image will be described with respect to an example where a pulsed spherical wave has been produced at point a2. With respect to the point in time when the spherical wave produced at point a2 arrives at the rectangular transducer T5 (the rectangular transducer closest to point a2), the other rectangular transducers Ti each output a pulsed time signal with a time delay of τi (τi>0). If the delay synthesis described above is performed where ti=τi (i=1, . . . , 15), the delay signals Si (t+ti) generated from the output signals from the rectangular transducers all have a pulsed time signal at the same point in time. As a result, the signal after the delay synthesis is a large pulsed time signal.

Now, consider a case where a pulsed spherical wave arrives also from another point a1. The output signal corresponding to the pulsed spherical wave produced at point a1 does not appear at the same point in time in the delay signals Si (t+ti) from the rectangular transducers in the delay synthesis. Therefore, in the signal obtained by delay synthesis, the output of the spherical wave signal from point a1 will be relatively small.

That is, through the delay synthesis process, the ultrasonograph shown in FIG. 13 only has a high sensitivity to ultrasonic signals from point a2 and does not substantially observe ultrasonic signals from other points.

Utilizing this property, if one sets the delay time ti (i=1, . . . , 15) so as to have a high sensitivity to a spherical wave from an intended point shown in FIG. 13 and repeatedly performs the delay synthesis each time the delay time is set, the spherical wave intensities from different points can be obtained, making it possible to obtain an ultrasonic image.

### SUMMARY

The ultrasonograph shown in FIG. 13 enables flexible imaging. This ultrasonograph, however, requires many iterations of a signal process (delay synthesis) for obtaining a single ultrasonic image. The required number of iterations of the signal process is at least equivalent to the number of pixels of the image. Therefore, to realize high-speed ultrasonic imaging, there will be a need for a signal processing circuit having a high-speed and large-scale arithmetic circuit. Moreover, in order to obtain an image with a large number of pixels and a high spatial resolution, there will be a need for a larger number of ultrasonic transducers with uniform wave-transmitting/receiving characteristics. However, constructing such a group of transducers will be very difficult.

A non-limiting example embodiment of the present application provides an acousto-optic imaging system capable of obtaining an image at a high speed even without a large-scale arithmetic circuit.

An acousto-optic imaging system of the present invention includes: an ultrasonic wave source for irradiating an imaged object with an ultrasonic wave made of an acoustic signal having a time waveform which is repeated at intervals of a predetermined amount of time; an acoustic lens arranged so as to receive a scattered wave of the ultrasonic wave, with which the imaged object has been irradiated; a light-transmitting acoustic medium provided in an area on an opposite side of the imaged object with respect to the acoustic lens, which area includes an optical axis of the acoustic lens therein; a light source for outputting a monochromatic light plane wave, the light source being arranged so that a traveling direction of the monochromatic light plane wave and the optical axis of the acoustic lens cross each other at an angle other than 90 degrees and 180 degrees; an image-forming lens arranged so as to condense diffraction light of the monochromatic light plane wave which is produced in the light-transmitting acoustic medium; an image-receiving section configured to obtain, as image information, an optical image formed by the image-forming lens; and a distortion compensation section configured to correct a distortion of the optical image or a distortion of an image generated from the image information.

With an acousto-optic imaging system according to one aspect of the present application, it is possible to image an imaged object at a high speed using ultrasonic waves.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF DRAWINGS

FIG. 1 is a schematic configuration diagram showing a configuration of an acousto-optic imaging system in Embodiment 1.

FIG. 2A is a diagram illustrating how a plane wave light beam 14 is diffracted in Bragg diffraction by a plane wave 9 in the acousto-optic imaging system of Embodiment 1.

FIG. 2B is a schematic diagram illustrating a Bragg diffraction condition in a one-dimensional diffraction grating.

FIG. 2C is a schematic diagram illustrating how the ultrasonic wavefront is mapped through Bragg diffraction onto a diffraction light beam.

FIG. 3A is a diagram illustrating how diffraction light 201 is distorted in one direction in the acousto-optic imaging system of Embodiment 1.

FIG. 3B is a schematic diagram illustrating the action of an anamorphic prism used as a distortion compensation section 15 of the acousto-optic imaging system of Embodiment 1.

FIG. 4 is a schematic diagram illustrating the action of a wedge-shaped prism forming the anamorphic prism.

FIG. 5A is a schematic configuration diagram illustrating an operation of a double diffraction optical system in the field of optics.

FIG. 5B is a schematic view showing a configuration of a double diffraction optical system as an acousto-optic mixed optical system of the acousto-optic imaging system of Embodiment 1.

FIG. 6 is a schematic view showing a specific configuration of the acousto-optic imaging system of Embodiment 1.

FIG. 7A is a schematic configuration diagram showing the direction of incidence of the plane wave light beam 14 in the acousto-optic imaging system of Embodiment 1.

FIG. 7B is a schematic configuration diagram showing another possible direction of incidence of the plane wave light beam 14 in the acousto-optic imaging system of Embodiment 1.

FIG. 8 is a schematic view showing a configuration of an acoustic lens 6 in an acousto-optic imaging system of Embodiment 2.

FIG. 9 is a schematic view showing a configuration example of the distortion compensation section 15 in an acousto-optic imaging system of Embodiment 3.

FIGS. 10A and 10B are schematic views each showing a configuration example of the distortion compensation section 15 in an acousto-optic imaging system of Embodiment 4.

FIG. 11 is a schematic configuration diagram showing a configuration of an acousto-optic imaging system in Embodiment 5.

FIG. 12A is a diagram showing a schematic configuration of the distortion compensation section 15 of an acousto-optic imaging system 600 of Embodiment 6.

FIG. 12B schematically shows a calibration sample.

FIG. 12C schematically shows an image of the obtained calibration sample before distortion correction.

FIG. 12D schematically shows an image of the calibration sample after distortion correction.

FIG. 13 is a schematic diagram showing the imaging principle of a conventional ultrasonograph described in Patent Document No. 1.

FIG. 14 is a schematic diagram showing a conventional Bragg imaging apparatus configuration described in Non-Patent Document No. 1.

### DETAILED DESCRIPTION

The present inventors made a research on an imaging apparatus capable of obtaining an image at a high speed using ultrasonic waves even without a large-scale arithmetic circuit. As a result, the present inventors conceived the idea of obtaining an image by utilizing the acousto-optical effect, which is an interaction between ultrasonic waves and light. Specifically, the present inventors conceived the idea of mapping information of an imaged object contained in ultrasonic scattered waves onto light waves, thereby obtaining an ultrasonic image as an optical image. A conventional technique applicable to such an object is what is called “Bragg imaging” (see, for example, A. Korpel, “Visualization of the cross section of a sound beam by Bragg diffraction of light,” Applied Physics Letters, vol. 9. no. 12, pp. 425-427, 15 Dec. 1966. hereinafter referred to as Non-Patent Document No. 1).

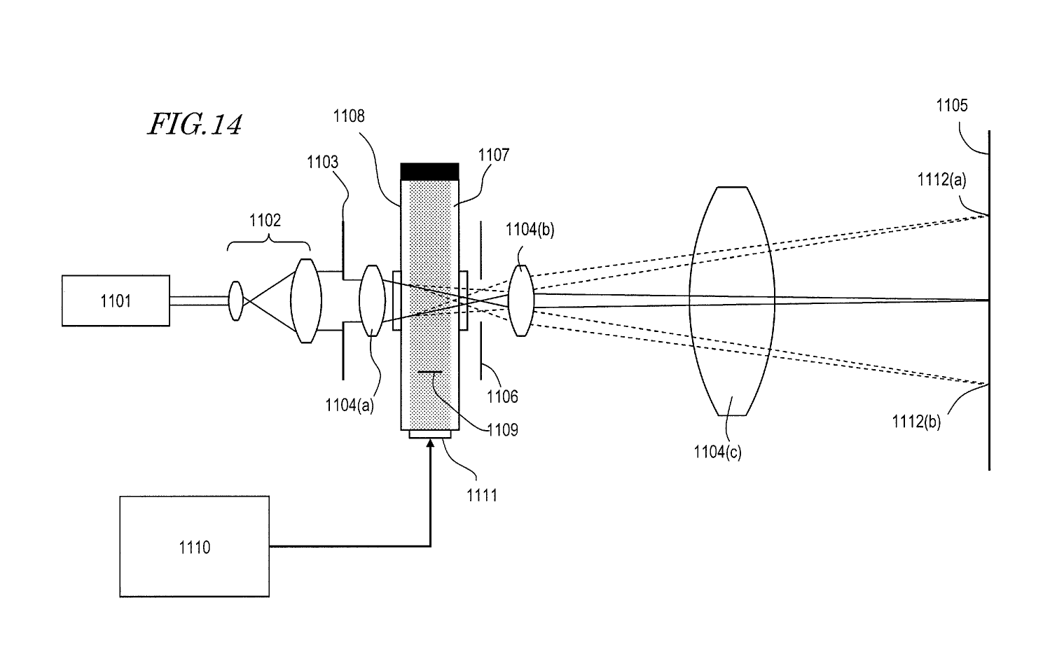

FIG. 14 is a diagram showing an apparatus configuration of an imaging apparatus using conventional Bragg imaging described in Non-Patent Document No. 1. In FIG. 14, a monochromatic light beam output from a laser light source 1101 is converted through a beam expander 1102 and an aperture 1103 into a broad plane wave light beam. Three cylindrical lenses 1104(a), 1104(b) and 1104(c) are arranged on the optical path of the light beam. The optical system shown in FIG. 14 has an asymmetric structure with respect to directions horizontal and vertical to the drawing sheet of FIG. 14. Therefore, the optical system has astigmatism, and the optical system is configured with the cylindrical lenses 1104(a), 1104(b) and 1104(c) in order to form an image at a single point on a screen 1105 in directions horizontal and vertical to the drawing sheet of FIG. 14.

The focal length of the cylindrical lens 1104(a) is set so that the plane wave light beam is focused on a focal plane (a plane which contains the focal point therein and whose normal coincides with the optical axis) 1106 on a plane horizontal to the drawing sheet. The light beam having passed through the focal plane 1106 diverges behind the focal plane 1106, but the diverging light beam is converged by the cylindrical lens 1104(b) and is focused again on the screen 1105. In the plane containing the optical axis therein and vertical to the drawing sheet of FIG. 14, the light beam having passed through the magnifying optical system 1102 is incident on the cylindrical lens 1104(c) while remaining as a collimated light beam. Then, by the light-condensing function of the cylindrical lens 1104(c), it is focused on the screen 1105. Note that the positions at which the cylindrical lenses 1104 are installed and the focal lengths thereof are set not only so that the light beam in the horizontal/vertical direction of FIG. 14 forms an image on the screen 1105 but also so that the magnification ratio (the size of an imaged object 1109/the size of the image on the screen 1105) is equal for images in the horizontal/vertical direction of FIG. 14.

In the apparatus configuration shown in FIG. 14, the imaged object 1109 is immersed in an acoustic cell 1108 filled with water 1107. The imaged object 1109 is irradiated with a monochromatic (single frequency) ultrasonic plane wave produced from an ultrasonic transducer 1111 driven by a signal source 1110 with the water 1107 interposed therebetween. Then, an ultrasonic scattered wave is generated at the imaged object 1109. The scattered wave propagates through an area in the water 1107 where monochromatic light output from the laser light source 1101 passes. Since the primary waveguide mode for ultrasonic waves propagating through water is the compressional wave (longitudinal wave), a sound pressure distribution in the water 1107, i.e., a refractive index distribution coincident with the ultrasonic wavefront, is generated in the water. Now, for ease of discussion, it is first assumed that the ultrasonic scattered wave from the imaged object 1109 is a plane wave traveling upward in FIG. 14. Since the ultrasonic scattered wave is a monochromatic ultrasonic wave, the refractive index distribution generated in the water 1107 at a certain moment is a sinusoidal one-dimensional grating that repeats at an ultrasonic wavelength. Thus, diffraction light is generated by the one-dimensional grating. Note that FIG. 14 only shows the ±1^{st}-order diffraction light beam for the sake of simplicity. Typically, diffraction light includes Bragg diffraction light and Raman-Nath diffraction light. The apparatus shown in FIG. 14 is used under conditions where the Bragg diffraction light is the primary diffraction light. In such a case, the only diffraction light generated are 0^{th}-order and ±1^{st}-order diffraction light. The diffraction light appears as a light spot on the screen 1105. The brightness of the light spot is in proportion to the amount of change in the refractive index of the one-dimensional grating, i.e., the sound pressure of the ultrasonic wave.

Now consider relaxing the prerequisite assumed above that “the ultrasonic scattered wave is a plane wave”. That is, consider a case of a typical ultrasonic scattered wave (where the wavefront is not planar). A typical ultrasonic scattered wave can be expressed as a superposition of plane waves coming from various directions (all plane waves have the same frequency in the example described above). Therefore, even with a typical ultrasonic scattered wave, light spots of diffraction light from unfolded plane waves appear on the screen 1105. The intensity of each light spot is in proportion to the magnitude of the amplitude of the plane wave, and the position at which each light spot appears on the screen 1105 is determined by the direction in which the plane wave travels. Therefore, an image of the imaged object 1109 appears on the screen 1105 as a 1^{st}-order diffraction image 1112(a) and a −1^{st}-order diffraction image 1112(b).

An operation for optically obtaining an ultrasonic image by the conventional Bragg imaging described in Non-Patent Document No. 1 is as described above.

Since image formation by Bragg imaging is done by the optical image-forming function of the light-condensing optical system, as with an ordinary optical camera, there is no need at all for the group of receivers or the signal processing means for the group of receive signals output from the group of receivers used in Patent Document No. 1 cited above. Thus, since Bragg imaging, with its apparatus configuration, does not require a high-speed and large-scale arithmetic circuit or a large number of ultrasonic transducers with uniform wave-transmitting/receiving characteristics, it is possible to solve the problem of Patent Document No. 1 described above.

While Bragg imaging is advantageous in many respects as described above, it has problems as follows. That is, it is difficult to realize a good image-forming property (a resolution dictated by an ultrasonic wavelength that is expected wave optics-wise); the apparatus will necessarily be large; and there are limitations on imaged objects that can be imaged.

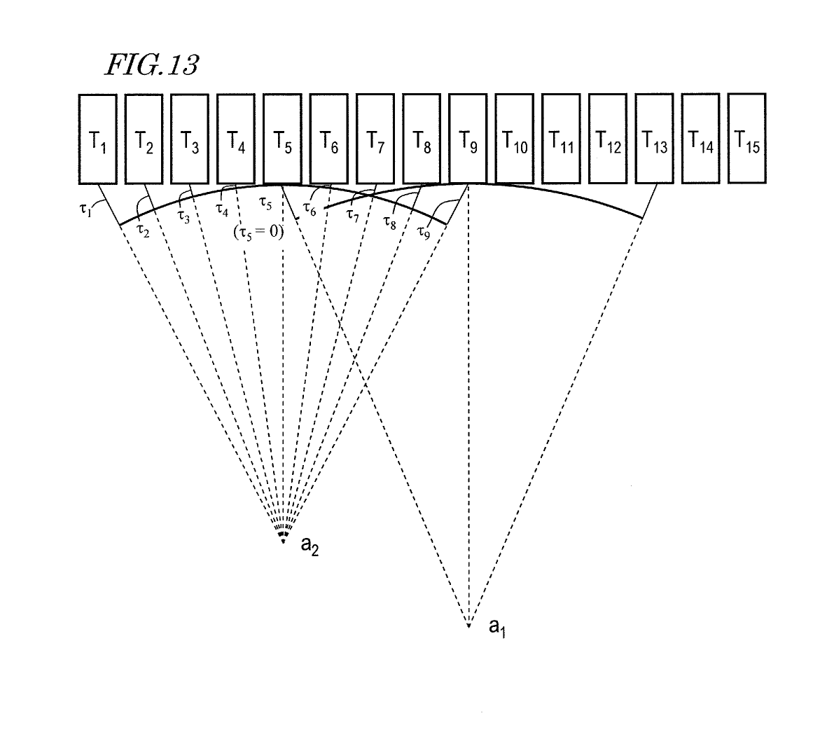

In FIG. 14, while images of the imaged object 1109 are ±1^{st}-order diffraction images 1112(a) and 1112(b), the ±1^{st}-order diffraction images 1112(a) and 1112(b) are formed significantly away from the optical axis in FIG. 14. Typically, an image-forming optical system has greater off-axis aberrations further away from the optical axis, and it is therefore difficult to form a good image on an image plane (a plane on which an image is formed) away from the optical axis. Therefore, with the optical system configuration shown in FIG. 13, the image deteriorates due to off-axis aberrations.

With the configuration shown in FIG. 14, the water 1107 is used as an ultrasonic wave propagation medium. Since the ultrasonic wave propagation speed is relatively high (about 1500 m/s) through water, if an ultrasonic wave having a frequency as high as 22 MHz described in Non-Patent Document No. 1 is used, the wavelength will be as larger as about 68 μm. Therefore, a laser having a wavelength of 633 nm described in Non-Patent Document No. 1 is used as the laser light source 1101, the diffraction angle of the +1^{st}-order diffraction images 1112(a) and 1112(b) will be very small (about 0.27°). Therefore, in order for the magnification ratio to be equal for images in the horizontal and vertical directions in FIG. 14, there is a need for a special optical system using a cylindrical lens for adjusting the focal length and the magnification ratio for each of the horizontal and vertical directions. It is also necessary to significantly increase the distance between the screen 1105 and the acoustic cell 1108 (about some m), thereby increasing the size of the apparatus. Moreover, with the configuration shown in FIG. 14, the imaged object 1109 needs to be sealed within the closed container filled with the water 1107, and it is therefore difficult to realize easy imaging such as with an ultrasonograph of Patent Document No. 1, for example.

In view of these problems, the present inventors conceived a novel acousto-optic imaging system, with which it is possible to form an optical image having a uniform and high resolution on an image plane with little aberrations; it is not necessary to seal an imaged object within a closed container filled with water; and it is possible to realize a small acousto-optic imaging system. The outline of one aspect of the present invention is as follows.

An acousto-optic imaging system in one aspect of the present invention includes: an ultrasonic wave source for irradiating an imaged object with an ultrasonic wave made of an acoustic signal having a time waveform which is repeated intervals of a predetermined amount of time; an acoustic lens arranged so as to receive a scattered wave of the ultrasonic wave, with which the imaged object has been irradiated, and convert the scattered wave to a plane wave; a light-transmitting acoustic medium provided in an area on an opposite side of the imaged object with respect to the acoustic lens, which area includes an optical axis of the acoustic lens therein; a light source for outputting monochromatic light plane wave, the light source being arranged so that a traveling direction of the monochromatic light plane wave and the optical axis of the acoustic lens cross each other at an angle other than 90 degrees and 180 degrees; an image-forming lens arranged so as to condense diffraction light of the monochromatic light plane wave which is produced in the light-transmitting acoustic medium; an image-receiving section configured to obtain, as image information, an optical image formed by the image-forming lens; and a distortion compensation section configured to correct a distortion of the optical image or a distortion of an image generated from the image information.

The ultrasonic wave is an acoustic signal whose carrier wave is a sinusoidal wave.

The ultrasonic wave has a pulsed time waveform of which a duration is greater than or equal to an inverse of a carrier wave frequency.

In one embodiment, the acoustic lens includes a focusing mechanism.

The acoustic lens is a refractive acoustic lens.

The acoustic lens is made of a silica nano porous material.

The acoustic lens is a reflective acoustic lens.

The acoustic lens is a cassegrain acoustic lens.

The light-transmitting acoustic medium is a silica nano porous material.

In one embodiment, the distortion compensation section includes an optical system for magnifying or reducing a cross-sectional area of a light beam of diffraction light of the monochromatic light plane wave which is produced in the light-transmitting acoustic medium, and corrects a distortion of the optical image by means of the optical system.

The optical system includes an anamorphic prism.

The optical system in the distortion compensation section is arranged between the light-transmitting acoustic medium and the image-forming lens.

The distortion compensation section corrects, through an image process, a distortion of an image generated from the image information obtained by the image-receiving section.

The acousto-optic imaging system further includes an angle adjustment section configured to adjust a position of the light source so that an angle formed by a traveling direction of the monochromatic light plane wave output from the light source with respect to the optical axis of the acoustic lens and an angle formed by a traveling direction of diffraction light of the monochromatic light plane wave with respect to the optical axis of the acoustic lens are equal to each other.

A distortion of the optical image or a distortion of an image generated from the image information is corrected based on the image information.

An acousto-optic imaging apparatus in one aspect of the present invention includes: an acoustic lens arranged so as to receive a scattered wave of an ultrasonic wave, with which an imaged object has been irradiated; a light-transmitting acoustic medium provided in an area on an opposite side of the imaged object with respect to the acoustic lens, which area includes an optical axis of the acoustic lens therein; a light source for outputting a monochromatic light plane wave, the light source being arranged so that a traveling direction of the monochromatic light plane wave and the optical axis of the acoustic lens cross each other at an angle other than 90 degrees and 180 degrees; an image-forming lens arranged so as to condense diffraction light of the monochromatic light plane wave which is produced in the light-transmitting acoustic medium; and an image-receiving section configured to obtain, as image information, an optical image formed by the image-forming lens.

Embodiments of the present invention will now be described with reference to the accompanying drawings.

### Embodiment 1

First, a first embodiment of the present invention will be described.

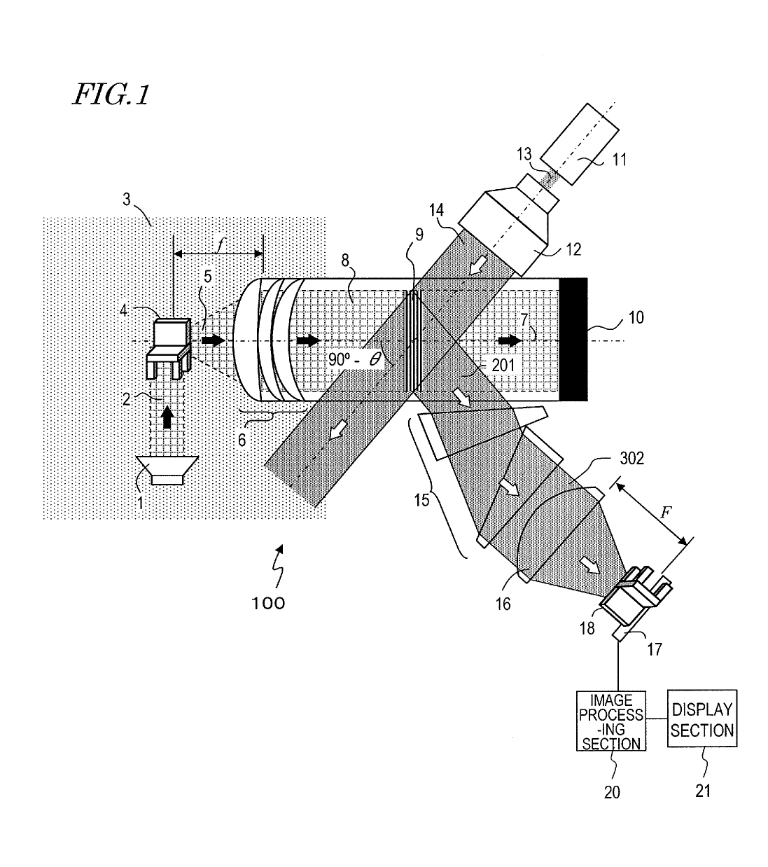

FIG. 1 is a diagram schematically showing a configuration of an acousto-optic imaging system 100 according to a first embodiment of the present invention. The acousto-optic imaging system 100 includes an ultrasonic wave source 1, an acousto-optic medium 8, an acoustic lens 6 arranged on one surface of the acousto-optic medium 8 that is closer to an imaged object 4, a sound wave absorbing end 10 arranged on one surface of the acousto-optic medium 8 opposite to the surface on which the acoustic lens 6 is arranged, a monochromatic light source 11, a beam expander 12, a distortion compensation section 15, an image-forming lens 16, and an image-receiving section 17. Note that the imaged object 4 and an image 18 shown in FIG. 1 are not components of the acousto-optic imaging system 100, but are shown for the purpose of illustration.

The ultrasonic wave source 1, the acoustic lens 6, a portion of the acousto-optic medium 8, and the imaged object 4 are arranged in a medium 3 capable of propagating ultrasonic waves. For example, the medium 3 is the air, water, or the like. Note that a body tissue is also a preferred example of the medium 3 capable of propagating ultrasonic waves. When imaging the inside of a body tissue, the ultrasonic wave source 1 and the acoustic lens 6 are arranged in contact with the medium 3, as is a probe used in a conventional ultrasonograph.

The acousto-optic imaging system 100 obtains an image of the imaged object 4 using ultrasonic waves. Components of the acousto-optic imaging system 100 will now be described.

<Ultrasonic Wave Source 1>

The ultrasonic wave source 1 irradiates the imaged object 4 with a pulsed ultrasonic wave 2 made of a plurality of waves of the same sinusoidal waveform. A pulsed ultrasonic wave 2 made of a plurality of waves of the same sinusoidal waveform means an ultrasonic wave having a time waveform where a sinusoidal waveform with a constant amplitude and frequency continues over a certain period of time. Thus, the ultrasonic wave source used in the present embodiment outputs an acoustic signal whose carrier wave is a sinusoidal wave. Now, the duration of the time waveform of the pulsed ultrasonic wave 2 is preferably set to be greater than or equal to the inverse of the carrier frequency (period). The pulsed ultrasonic wave 2 does not need to be a plane wave.

The pulsed ultrasonic wave 2 irradiates an area of the imaged object 4 that is intended to be imaged with generally a uniform radiation intensity. In order to irradiate the imaged object 4 with generally a uniform radiation intensity, the pulsed ultrasonic wave 2 in the present embodiment is an ultrasonic wave packet having a beam cross section that is at least larger than the area that can be imaged by the acousto-optic imaging system 100. Herein, “to irradiate with generally a uniform radiation intensity” means that the irradiation is done so that a uniform sound pressure is applied across an imaging area assumed in advance by the designer of the acousto-optic imaging system 100. An imaging area refers to an area around the object-side focal point of the acoustic lens 6. For example, where the imaging area is an area of a 10-mm radius around the focal point, it is only needed that an area of a 10-mm radius around the focal plane be irradiated uniformly.

When the imaged object 4 is irradiated with the pulsed ultrasonic wave 2, a scattered wave 5 having the same frequency as the pulsed ultrasonic wave 2 is generated. Note that it is understood that the scattered wave 5 is also an ultrasonic wave.

<Acoustic Lens 6>

The acoustic lens 6 is configured to converge ultrasonic waves. The acoustic lens 6 has a focal length f in the medium 3. The acoustic lens 6 is configured as a combination of a plurality of reflective surfaces for ultrasonic waves by, for example, providing an elastic member with little ultrasonic propagation loss processed into an optical lens shape, or by smoothing, as if with a reflecting mirror in the field of optics, the surface of a material (metal, glass, and the like) whose acoustic impedance is significantly different from that of the medium 3.

For ease of discussion, the imaged object 4 is assumed to be located around the focal point of the acoustic lens 6. That is, the distance between the acoustic lens 6 and the imaged object 4 is about the focal length f. Note that in an actual imaging scene, the distance between the imaged object 4 and the acoustic lens 6 does not have to strictly coincide with the focal length f. The degree by which the distance between the imaged object 4 and the acoustic lens 6 is allowed to be shifted from the focal length f is dependent on the resolution required for the imaging.

Next, the scattered wave 5 produced as the imaged object 4 is irradiated with the pulsed ultrasonic wave 2 will be taken note of. The scattered wave 5 is a spherical wave produced at the focal position of the acoustic lens 6 (the position of the imaged object 4) and centered about the focal point. The scattered wave 5 is refracted through the acoustic lens 6 and is converted to a plane wave 9 propagating through the acousto-optic medium 8 in the direction parallel to an optical axis 7. Since the imaged object 4 is irradiated with the pulsed ultrasonic wave 2, the plane wave 9 is a wave packet of a pulsed plane wave as shown in FIG. 1. In the present specification, an acoustic lens for converting an ultrasonic wave which is incident through refraction to a wave packet of a plane wave as described above is referred to as the “refractive type”. A surface of the acoustic lens 6 that receives the scattered wave 5 is denoted as a first surface, and the other surface as a second surface. The acoustic lens 6 may have a plurality of second surfaces.

<Acousto-Optic Medium 8>

The acousto-optic medium 8 is a light-transmitting acoustic medium. The plane wave 9 propagates through the acousto-optic medium 8. The acousto-optic medium 8 is arranged in contact with the second surface of the acoustic lens 6. That is, it is arranged on a surface of the acoustic lens 6 other than the surface on which the scattered wave 5 is incident. In other words, the acousto-optic medium 8 is arranged in an area on the opposite side of the imaged object 4 with respect to the acoustic lens 6. A plane wave light beam 14 to be described later is also incident on the acousto-optic medium 8. The acousto-optic medium 8 is formed by, for example, a porous material formed by a silica dry gel, water, an optical glass, or the like. That is, it may be any isometric medium capable of propagating a compressional acoustic signal therethrough, and capable of transmitting light emitted from the monochromatic light source 11 therethrough. Note that where an image of a high resolution is obtained by the acousto-optic imaging system 100, a medium having as low a sonic speed as possible is preferably used as the acousto-optic medium 8.

The acoustic lens 6 and the sound wave absorbing end 10 are arranged on the opposing end surfaces of the acousto-optic medium 8. The plane wave 9 having been converted through the acoustic lens 6 is incident on the acousto-optic medium 8 and propagates therethrough. The propagating plane wave 9 is not reflected, but is absorbed, by the sound wave absorbing end 10 arranged on the end surface of the acousto-optic medium 8. Note that while the sound wave absorbing end 10 is preferably provided as in the present embodiment in order to prevent the reflection of the plane wave 9, it is possible to implement the present system without the provision of the sound wave absorbing end 10.

It is preferred that an acoustic matching layer is provided between components of the acousto-optic medium 8, the acoustic lens 6 and the sound wave absorbing end 10, and these three components are in contact together. With the provision of the acoustic matching layer, it is possible to suppress the influence of reflection waves produced on the end surfaces of the three components. The reflection wave produced on the refractive surface of the acoustic lens 6 leads to a decrease in transmitted light, thereby causing the brightness of the image 18 to be lowered. Moreover, reflection waves produced on the refractive surface of the acoustic lens 6, the interface between the sound wave absorbing end 10 and the acousto-optic medium 8, and end surfaces of the acousto-optic medium 8 that are not in contact with the sound wave absorbing end 10 cause the image quality of the image 18 to be lowered. These reflection waves are equivalent to stray light in the field of optics, and do not contribute to image formation. An increase in these reflection waves leads to a decrease in the S/N ratio of the image, a decrease in the contrast, and superposition of an image (ghost) other than the image of the imaged object 4. Primary components of these reflection waves are the component produced on the refractive surface of the acoustic lens 6, and the component produced on the surface of the acousto-optic medium 8 that is in contact with the sound wave absorbing end 10. Therefore, it is preferred to provide an acoustic matching layer between the three components to suppress the production of reflection waves from these three components.

<Monochromatic Light Source 11>

The monochromatic light source 11 generates a highly coherent light beam. Herein, a “highly coherent light beam” means a light beam made of a group of photons having a uniform wavelength, traveling direction and phase. The monochromatic light source 11 outputs a light beam toward the acousto-optic medium 8.

The beam expander 12 is arranged between the monochromatic light source 11 and the acousto-optic medium 8. The light beam output from the monochromatic light source 11 is shaped into the plane wave light beam 14 by passing through the beam expander 12. The beam expander expands the light beam output from the monochromatic light source 11 so that the plane wave light beam 14 sufficiently uniformly irradiates the area of the acousto-optic medium 8 where the plane wave 9 propagates. In order to capture the entirety of the imaged object 4 as an image, the beam expander 12 is preferably configured to uniformly irradiate the entirety of one wavefront of the plane wave 9 shown in FIG. 1.

With the configuration described above, the plane wave light beam 14 enters the acousto-optic medium 8. An optical axis 13 of the monochromatic light source 11 crosses the optical axis 7 of the acousto-optic medium 8. The crossing angle between the optical axis 7 and the optical axis 13 is (90°−θ). Herein, θ represents the angle formed between the traveling direction of the plane wave light beam 14 and the wavefront of the plane wave 9. Note that θ can take any angle except for 0 degree, 90 degrees, 180 degrees and 270 degrees. This is because the plane wave light beam 14 undergoes Bragg diffraction to generate diffraction light 201 as long as θ is an angle other than 0 degrees, 90 degrees, 180 degrees and 270 degrees.

As described above, the acousto-optic medium 8 is transmissive to the light beam emitted from the monochromatic light source 11. After entering the acousto-optic medium 8, the plane wave light beam 14 comes into contact with the plane wave 9. The plane wave light beam 14 having come into contact with the plane wave 9 is split into light that passes therethrough and the diffraction light 201.

<Behavior of Plane Wave Light Beam 14>

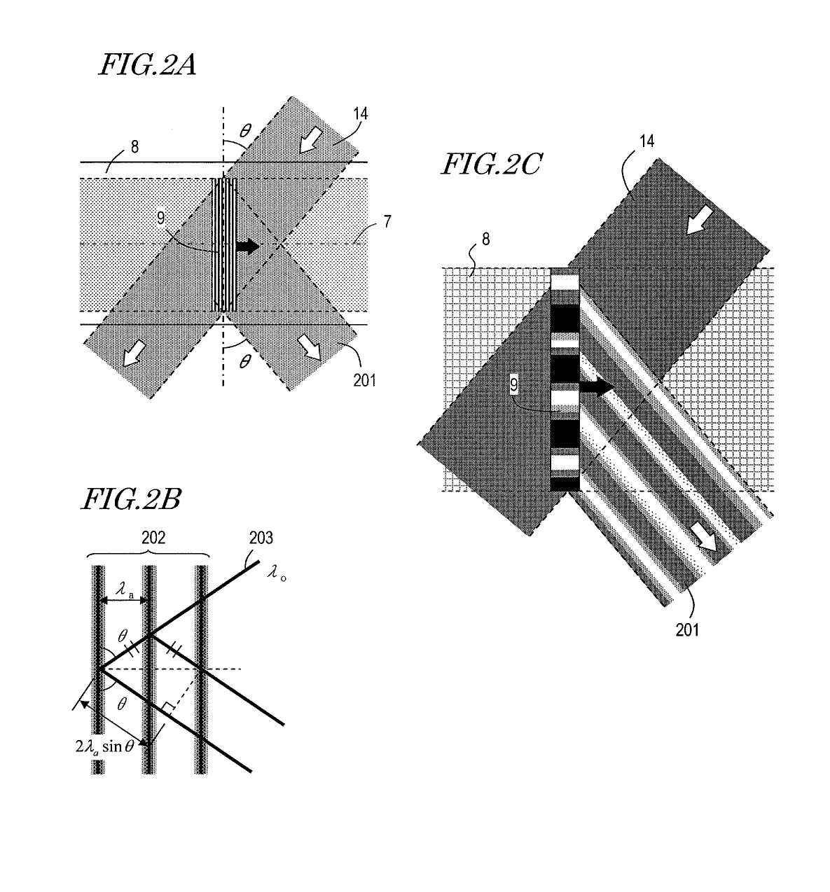

Next, referring to FIG. 2, the behavior of the plane wave light beam 14 when the plane wave light beam 14 irradiates the plane wave 9 will be described.

FIG. 2A is a diagram showing how the plane wave light beam 14 is Bragg-diffracted by the plane wave 9 in the acousto-optic imaging system 100. FIG. 2A shows the moment when the plane wave 9 passes through the plane wave light beam 14. The plane wave 9, which is an ultrasonic wave, is a compressional wave propagating through the acousto-optic medium 8. That is, a refractive index distribution coincident with the sound pressure distribution of the plane wave 9 is generated in the acousto-optic medium 8. Since the plane wave 9 has a single frequency in the present embodiment, the period of the refractive index distribution is equal to the wavelength of the plane wave 9. The acousto-optic medium 8 becomes a one-dimensional grating that changes in a sinusoidal wave pattern in the direction of the optical axis 7 and that has a uniform refractive index in the direction parallel to the plane whose normal coincides with the optical axis 7. Since this one-dimensional grating functions as a diffraction grating, the diffraction light 201 occurs when the plane wave light beam 14 propagates through the acousto-optic medium 8. Note that where the grating plane of the one-dimensional grating is a plane and the wavefront of the plane wave light beam 14 is a plane, the diffraction light 201 is a plane wave. As shown in FIG. 2A, the angles the plane wave light beam 14 and the diffraction light 201 form with respect to the plane whose normal coincides with the optical axis 7 are equal to each other, and are both θ. The angle θ is a discrete value that satisfies the Bragg diffraction condition to be described later.

FIG. 2B is a schematic diagram illustrating the Bragg diffraction condition in a one-dimensional diffraction grating. As shown in FIG. 2B, the grating interval of a diffraction grating 202 generated by the plane wave 9 is equal to the ultrasonic wave propagating wavelength λa through the acousto-optic medium 8. When monochromatic light 203 having the wavelength λo is incident on the diffraction grating 202, weak scattered light is generated at each grating portion. Taking note of scattered light from two adjacent grating planes, when the optical path length difference (2×λa×sin θ) between two light beams scattered in the same direction by grating portions is equal to an integer multiple of the wavelength λo (m×λ0, m=±1, ±2, . . . ), the two scattered light beams augment each other. This augmentation occurs also on other grating planes, thereby producing scattered light having a high intensity as a whole, i.e., diffraction light.

Based on the augmentation condition, the angle θ at which diffraction light appears can be expressed by Expression 1 below.

[Exp. 1]

θ=Arcsin(mλo/2λa),(m=±1, ±2, . . . ) (Expression 1)

where Arcsin represents an inverse sine function. The condition represented by Expression 1 is the Bragg diffraction condition.

The smaller the order m is, the higher the intensity of the diffraction light 201, and it is therefore preferred to use the diffraction light 201 where m=±1 for the acousto-optic imaging system 100.

FIG. 2C is a schematic diagram illustrating how the ultrasonic wavefront is mapped onto the diffraction light beam by Bragg diffraction. Referring to FIG. 2C, the behavior of the diffraction light 201 when the plane wave 9 has a sound pressure distribution in the wavefront plane will be described. Now, it is assumed that the wavefront of the plane wave 9 is a plane. As shown in FIG. 2C, the plane wave 9 has a non-uniform sound pressure distribution across the wavefront plane. The non-uniformity reflects the non-uniformity of the intensity distribution of the scattered ultrasonic wave from the imaged object 4. The sound pressure of the plane wave 9 is in proportion to the change in the refractive index of the acousto-optic medium 8. Since the amplitude of the diffraction light 201 (the light intensity to the power of ½) is in proportion to the magnitude of the refractive index change, the amplitude distribution of the diffraction light 201 is in proportion to the sound pressure distribution of the plane wave 9. Therefore, under a circumstance shown in FIG. 2C, the diffraction light 201 of the plane wave light beam 14 having a uniform light intensity is a plane wave onto which the sound pressure distribution of the plane wave 9 has been mapped. Herein, to “map” means that the diffraction light 201 has an optical intensity distribution that corresponds to the sound pressure distribution of the plane wave 9. That is, the wave optics-wise information of the plane wave 9 will all be taken over by the diffraction light 201.

<Distortion Compensation Section 15>

Next, the distortion compensation section 15 of the present embodiment will be described.

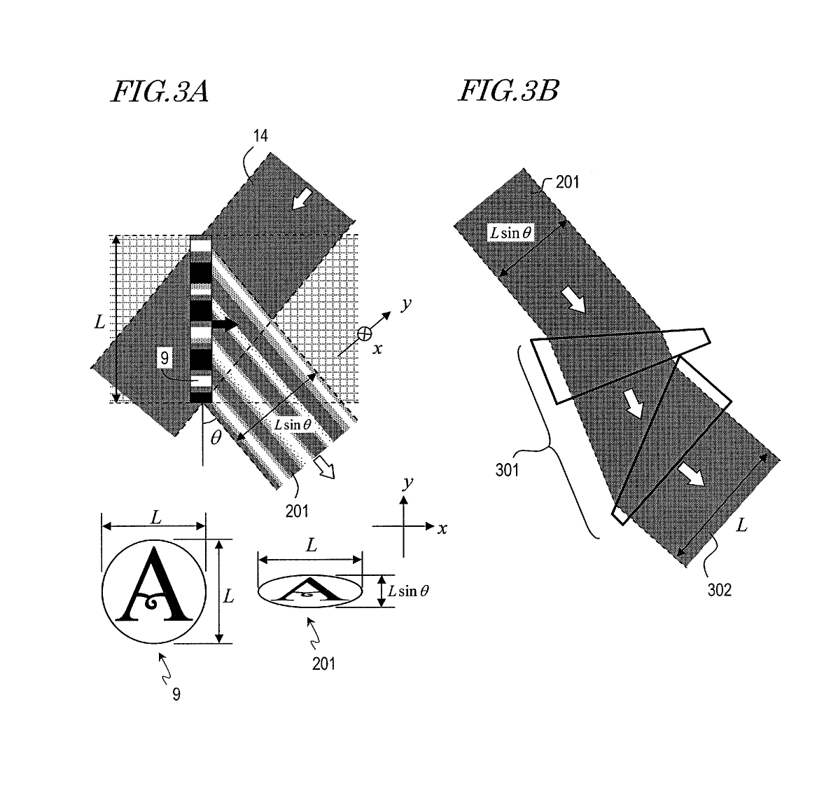

FIG. 3A is a diagram schematically showing how the diffraction light 201 is distorted in one direction in the acousto-optic imaging system 100. As shown in FIG. 3A, the plane wave light beam 14 is incident on the plane wave 9 in a diagonal direction. Thus, the diffraction light 201 is distorted in a direction that is parallel to the drawing sheet of FIG. 3A and is vertical to the propagation direction of the diffraction light 201. That is, the diffraction light 201 is distorted in the y-axis direction in the x-y plane shown in FIG. 3A.

Herein, it is assumed that the beam shape of the plane wave 9 is a circular shape having a diameter of L, and the Bragg diffraction angle is θ. The beam shape of the diffraction light 201 is an elliptical shape having a minor axis length of L×sin θ in the y-axis direction and a major axis length of L in the x-axis direction.

In the acousto-optic imaging system 100, a distortion of the diffraction light 201 cause a distortion of the image 18 shown in FIG. 1. Therefore, in the present embodiment, the distortion of the diffraction light 201 is corrected by the distortion compensation section 15 shown in FIG. 1. The distortion compensation section 15 in the present embodiment is formed by an anamorphic prism 301.

FIG. 3B is a diagram schematically showing the function of the anamorphic prism 301, which is used as the distortion compensation section 15 in the present embodiment. As shown in FIG. 3B, the anamorphic prism 301 is formed by two wedge-shaped prisms.

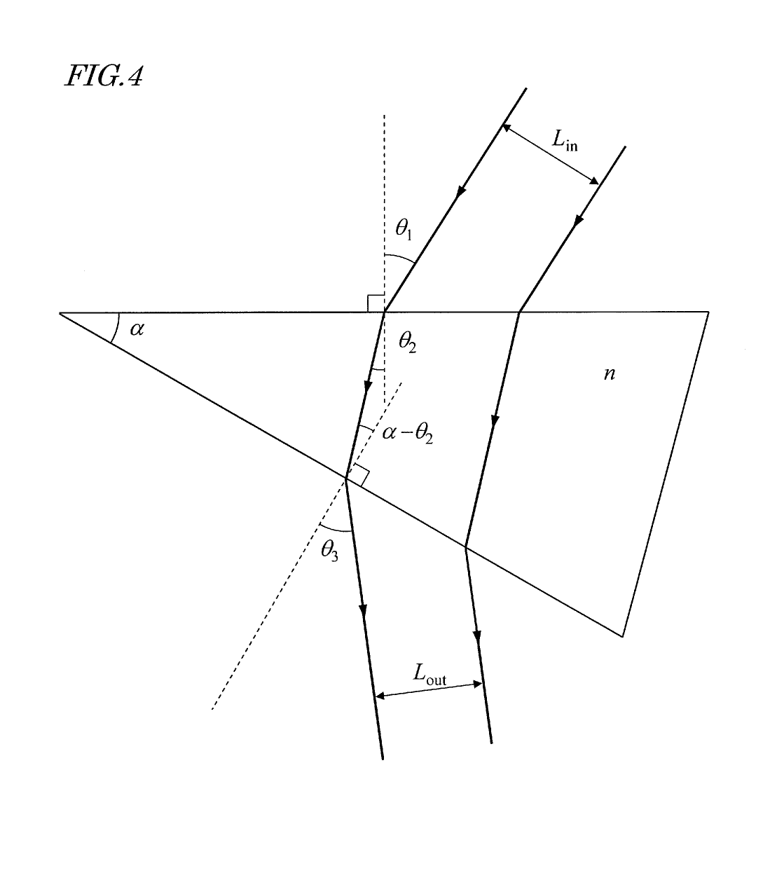

FIG. 4 is a diagram showing an example of one wedge-shaped prism. The wedge-shaped prism is made of a glass material having a refractive index of n. Normals to the two refractive surface of the wedge-shaped prism are both parallel to the drawing sheet of FIG. 4. Assume that the angle formed between the two refractive surfaces is a. When a light beam parallel to the drawing sheet of FIG. 4 enters this wedge-shaped prism, a light beam parallel to the drawing sheet of FIG. 4 is output from the wedge-shaped prism. That is, FIG. 4 shows a light beam that enters along a plane determined by normals to the two refractive surfaces of the wedge-shaped prism.

Assume that the angle of incidence of such a light beam on the first refractive surface is θ1, the output angle thereof from the first refractive surface is θ2, and the output angle thereof from the second refractive surface is θ3. Also assume that in FIG. 4, the width of the light beam entering the first refractive surface is Lin, and the width of the light beam output from the second refractive surface is Lout. Then, θ2 and θ3 can be obtained from Expression 2 below if θ1, α and n are given.

[Exp. 2]

sin θ1=n×sin θ2

n×sin(α−θ2)=sin θ3 (Expression 2)

As shown in FIG. 4, the beam diameter of the incoming light and the beam diameter of the outgoing light from the wedge-shaped prism are different from each other. The light beam magnification ratio calculated by Lout/Lin is expressed by Expression 3 below.

$$\begin{matrix}( Expression 3 ) & \\ \frac{{L}_{out}}{{L}_{in}} = \sqrt{\frac{{n}^{2} + ( {n}^{2} - 1 ) {tan}^{2} {θ}_{1}}{{n}^{2} + ( {n}^{2} - 1 ) {tan}^{2} {θ}_{3}}} & [ Exp . 3 ]\end{matrix}$$

It can be seen from Expression 3 that an intended light beam magnification ratio can be realized by determining α and n of the wedge-shaped prism, and the angle of incidence θ1.

Reference is again made to FIG. 3B. The anamorphic prism 301 is formed by combining one or more wedge-shaped prism shown in FIG. 4. Note that using two identical wedge-shaped prisms as shown in FIG. 3B is advantageous in that the direction of the incoming light to the anamorphic prism 301 and the direction of the outgoing light can be made parallel to each other, making it easy to adjust the optical system. Arranging the wedge-shaped prisms so that normals to the refractive surfaces thereof are parallel to the drawing sheet of FIG. 3B advantageously enhances the effect of correcting the distortion of the diffraction light 201 by means of the anamorphic prism 301. The distortion compensation section 15 is not limited to the example described above, and it may be any optical system as long as it is an optical system that magnifies the beam diameter of the diffraction light 201 only in the direction parallel to the plane including the optical axis 7 and the optical axis 13 shown in FIG. 1.

As shown in FIG. 3B, with respect to the direction in which the diffraction light 201 has been distorted, the beam diameter is magnified by a factor of 1/sin θ through the anamorphic prism 301. This compensates for the distortion of an image with respect to the direction parallel to the drawing sheet of FIG. 3B, thereby obtaining diffraction light 302 having a circular light beam cross section having a diameter of L. While the diffraction light 302 after distortion compensation is monochromatic light and is different in that the wavelength is significantly shorter than that of the plane wave 9, which is an ultrasonic wave, the wavefront circumstances of the plane wave 9 are all reproduced on the wavefront of the diffraction light 302 after distortion compensation.

As shown in FIG. 1, the diffraction light 302 after distortion compensation is condensed through the image-forming lens 16 having a focal length of F. Since the diffraction light 302 after distortion compensation is a collimated light beam, it is condensed to a focal point of the image-forming lens 16. The image-receiving section 17 is provided at the focal position of the image-forming lens 16. The image-receiving section 17 is typically a solid-state image sensing device such as a CCD or a CMOS, which obtains, as an optical image, the optical intensity distribution around the focal point of the image-forming lens 16, and converts it to an electrical signal. Note that the image-receiving section 17 is not limited to a solid-state image sensing device, but may be for example a photographic film, as long as the optical image formed on the imaging plane thereof can be captured as image information.

Where a solid-state image sensing device is used as the image-receiving section 17, the acousto-optic imaging system 100 may further include an image processing section 20 for receiving an electrical signal, which is image information, output from the image-receiving section 17 to perform an image process thereon, and a display section 21 for receiving an image signal having been image-processed by the image processing section 20 to display the obtained image.

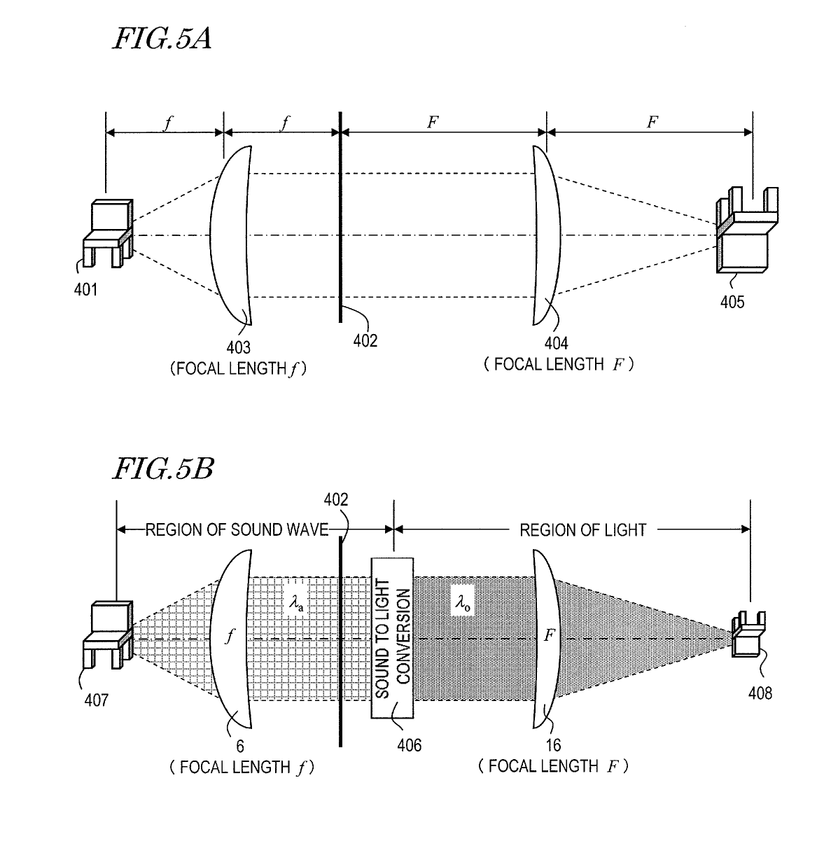

Next, referring to FIG. 5, it will be explained that the optical intensity distribution around the focal point of this image-forming lens 16 is the image 18 similar to the imaged object 4.

FIG. 5A is a diagram showing a schematic configuration illustrating an operation of a double diffraction optical system in the field of optics. FIG. 5A shows an optical system formed by two optical lenses 403 and 404 having focal lengths of f and F, respectively. The two lenses are spaced apart from each other by an interval f+F, and the optical axes of the lenses coincide with each other. According to Fourier optics, the two focal points of one light-condensing lens are in a Fourier transform relationship with each other. Therefore, a Fourier-transformed image of an object 401 obtained by the lens 403 is formed on an Fourier transform plane 402, which is the other focal plane (a plane which contains the focal point therein and whose normal coincides with the optical axis). Since the Fourier transform plane 402 is also a focal plane of the lens 404, a Fourier-transformed image of the Fourier-transformed image of the object 401 formed on the Fourier transform plane 402 is formed on the other focal plane of the lens 404. That is, the optical image formed on the other focal plane of the lens 404 is equivalent to what is obtained by performing a Fourier transform twice on the object 401. However, the twice-Fourier-transformed image of the object 401 (an image 405) has a shape similar to the object 401. More accurately, the image 405 appears on the focal plane of the lens 404 as an inverted image of the object 401, and the size thereof is F/f times the object 401. That is, in this optical system, an optical image similar to the object 401 appears as the image 405, and the object 401 can be imaged by installing an image sensing device such as a CCD on the focal plane on the right side of the lens 404 in FIG. 5A.

An acousto-optic mixed optical system by the acousto-optic imaging system 100 according to the present embodiment basically has the same function as the optical system shown in FIG. 5A. As described above referring to FIGS. 2 and 3, the mechanism for generating the diffraction light 201 by Bragg diffraction and the distortion compensation section 15 shown in FIG. 1 can be regarded as serving to convert the amplitude distribution of the plane wave 9 to an amplitude distribution of the diffraction light 302 after distortion compensation. More specifically, the acousto-optic mixed optical system shown in FIG. 1 can be regarded as including an acousto-optical conversion section 406 for mapping the amplitude distribution (sound pressure distribution) on the wavefront of the plane wave 9 having the wavelength λa onto the amplitude distribution (optical intensity distribution) of the diffraction light 302 after distortion compensation, which is a plane wave of the wavelength λo, as shown in FIG. 5B. Therefore, the acousto-optic mixed optical system in the acousto-optic imaging system 100 has a similar function as that of an optical system in which the acousto-optical conversion section 406 is inserted in the optical system of FIG. 5A.

The only difference between FIG. 5A and FIG. 5B is that the wavelength of the plane wave changes from λa to λo through the acousto-optical conversion section 406. Thus, the acousto-optic mixed optical system in the acousto-optic imaging system 100 is a double diffraction optical system as is the configuration shown in FIG. 5A. Therefore, according to Fourier optics, an image 408 is an optical image similar to an object 407, and appears upside down on the focal plane of the image-forming lens 16. Note that since the wavelength changes from λa to λo through the acousto-optical conversion section 406, the size of the image 408 is (F×λo)/(f×λa) times the object 407. Note that where λo/λa is very small, i.e., where the wavelength of the ultrasonic wave is very long as compare with the wavelength of the diffraction light 302 after distortion compensation, F/f is preferably increased. By increasing F/f, it is possible to prevent the image 408 from becoming very small, and to suppress lowering of the resolution of the optical image obtained by the image-receiving section 17.

<Specific Configuration Example>

Next, a more specific configuration example of the acousto-optic imaging system 100 according to the present embodiment will be described.

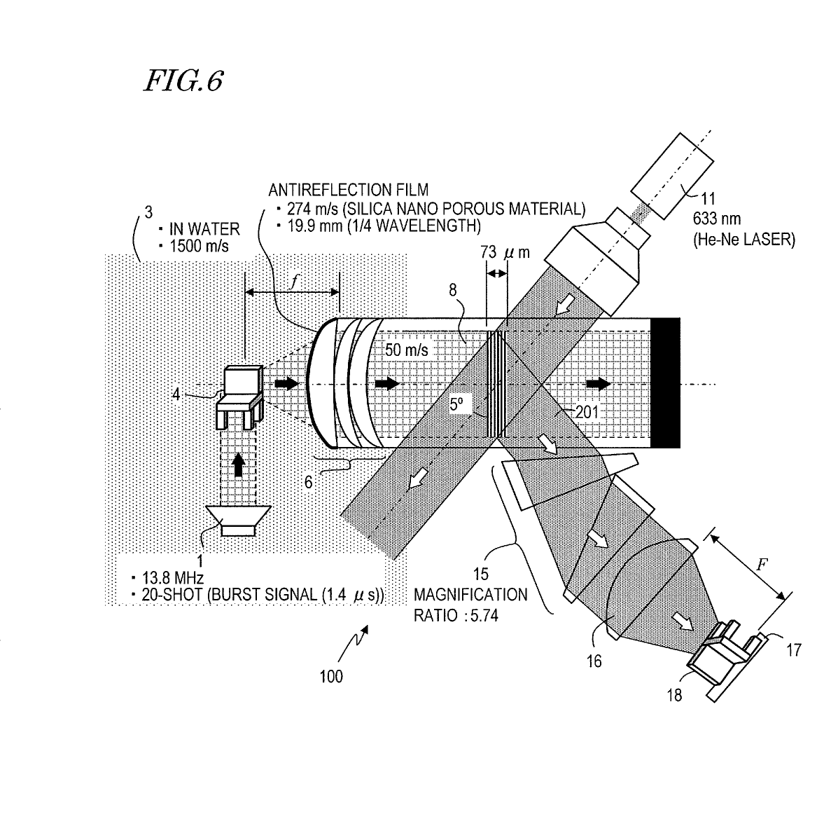

FIG. 6 is a diagram showing a more specific configuration example of the acousto-optic imaging system 100. In this configuration example, the medium 3 is water. The ultrasonic wave source 1 outputs a 20-shot burst signal of 13.8 MHz. A 20-shot burst signal has a signal duration of 1.4 μs. The length of the signal in water is 0.1 mm.

A silica nano porous material having a sonic speed of 50 m/s is used as the acousto-optic medium 8. A silica nano porous material having a relative low sonic speed has a short ultrasonic wave propagating wavelength, and the diffraction angle can be made large. Moreover, a silica nano porous material is transmissive to He—Ne laser light having a wavelength of 633 nm to be described later.

An He—Ne laser having a wavelength of 633 nm is used as the monochromatic light source 11. Where an He—Ne laser having a wavelength of 633 nm is used, the diffraction angle of the 1^{st}-order diffraction light is 5°. When the diffraction angle of the 1^{st}-order diffraction light is 5°, the beam magnification ratio that needs to be realized by the distortion compensation section 15 is about 5.74. This beam magnification ratio is achievable with commercially-available anamorphic prisms.

Since the diffraction light intensity is normally weak, the image-receiving section 17 desirably has a high sensitivity. Moreover, the image-receiving section 17 is desirably capable of high-speed imaging in order to prevent a scattered wave that has been scattered by the imaged object 4 at a different point in time from being superimposed on the image 18. That is, the image-receiving section 17 is preferably an image sensing device having a relatively high sensitivity and capable of high-speed imaging. A CCD image sensor (Charge Coupled Device Image Sensor) or a CMOS image sensor (Complementary Metal Oxide Semiconductor Image Sensor), for example, may be used as the image-receiving section 17. Where imaging is difficult because the brightness of the image 18 is insufficient, it is preferred that an image intensifier tube is arranged immediately preceding the image sensor to increase the brightness of the image 18.

It is preferred that an antireflection film is provided at the interface between the acoustic lens 6 and the medium 3 so that ultrasonic waves can efficiently enter the acoustic lens 6 from the medium 3. The antireflection film prevents the return loss of ultrasonic waves from the refractive surface of the acoustic lens 6 to the medium 3.

For example, where a silica nano porous material having a sonic speed of 50 m/s and a density of 0.11 g/cm̂3 is used as the acoustic lens 6, an antireflection film can be obtained by forming a 6.2-μm thin film of a silica nano porous material having a sonic speed of 340 m/s and a density of 0.27 g/cm̂3. The sonic speed of the antireflection film and the thickness thereof are determined based on the sonic speed of the acoustic lens 6 because the antireflection film is a film having a ¼-wavelength thickness made of a medium having an acoustic impedance that is represented by the geometric mean between the acoustic impedance (defined as the product between the sonic speed and the density) of the acoustic medium of the acoustic lens 6 and the acoustic impedance of the medium 3.

When the image 18 whose size is ⅕ of the imaged object 4 is to be obtained on the image-receiving section 17, F/f=1.14. The reason for this is as follows. That is, since the size ratio of the image 408 with respect to the object 407 is (F×λo)/(f×λa) as shown in FIG. 6, the relational expression of (F×λo)/(f×λa)=⅕ holds true in this example. Thus, F/f=λa/5λo, and substituting the wavelength λo=633 nm of light and the wavelength λa=3.6 μm of 13.8-MHz ultrasonic wave in a silica nano porous material having a sonic speed of 50 m/s into the expression above yields F/f=1.14.

Where the acoustic lens 6 having a focal length of 50 mm is used, the image-forming lens 16 having a focal length of 57 mm may be used. The reason for this is as follows. That is, F=1.14×f because F/f=1.14 as calculated above. Since f=50 mm in this example, F=1.14×50 mm=57 mm.

Increasing the size of the image 408 with respect to the object 407 in FIG. 5B will increase the focal length of the image-forming lens 16, thus increasing the size of the acousto-optic imaging system 100. Where the focal length of the image-forming lens 16 is increased, a folded optical system such as a cassegrain optical system, for example, may be used as an optical system of the image-forming lens 16 in order to configure, with a small size, the acousto-optic imaging system 100. The acousto-optic imaging system 100 can be made smaller by arranging the acoustic lens 6 and the image-forming lens 16 so that the distance therebetween is shorter than f+F. When arranging the acoustic lens 6 and the image-forming lens 16 so that the distance therebetween is shorter than f+F, it will no longer be a true double diffraction optical system. However, it functions in a similar fashion to a true double diffraction optical system in that an optical image similar to the imaged object 4 is made to appear as the image 18.

While the focal length of the acoustic lens 6 is assumed to be fixed in the present embodiment, the acoustic lens 6 may have a focusing mechanism (focal length adjusting mechanism) as with an ordinary photographic lens. Where the focal point of the acoustic lens 6 is fixed, a sharp image 18 is obtained only for a portion of the imaged object 4 included in an area around the focal plane of the acoustic lens 6 (accurately, an area determined by the depth of field). In view of this, a mechanism allowing for the adjustment of the focal length of the acoustic lens 6 may be integrated with the acoustic lens 6, thereby enabling imaging of a wider area of the imaged object 4.

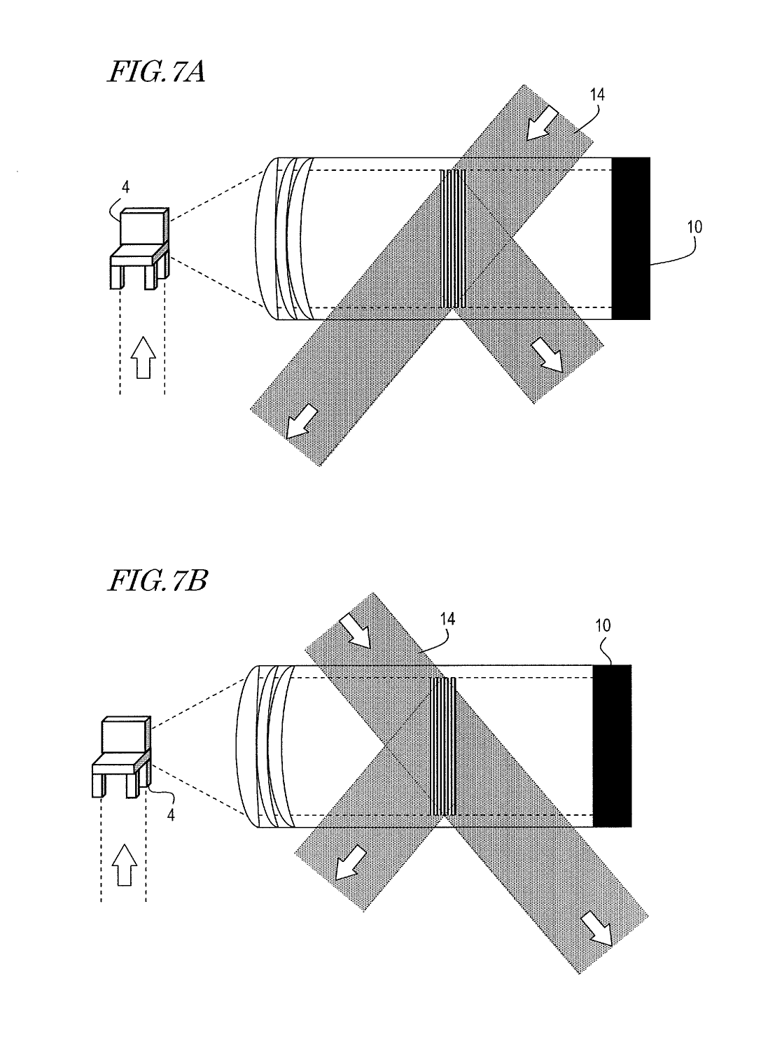

FIG. 7 shows diagrams showing variations with regard to the direction of incidence of the plane wave light beam 14. FIG. 7A shows the direction of incidence of the plane wave light beam 14 in the acousto-optic imaging system 100 according to the present embodiment. FIG. 7B shows another possible direction of incidence of the plane wave light beam 14 in the acousto-optic imaging system 100. In the present embodiment, the plane wave light beam 14 is output from the side of the sound wave absorbing end 10 toward the side of the imaged object 4 in a direction inclined with respect to the ultrasonic wave propagation direction as shown in FIG. 7A. The plane wave light beam 14 is not limited to such a direction, but the plane wave light beam 14 may be output from the side of the imaged object 4 toward the side of the sound wave absorbing end 10 in a direction inclined with respect to the ultrasonic wave propagation direction as shown in FIG. 7B. Note however that with the configuration shown in FIG. 7B, there is obtained an image that is a mirror image of the image obtained with the configuration of FIG. 7A, with the drawing sheet of FIG. 7B being the plane of symmetry. Therefore, in order to obtain a correct image 18 of the measured object 4, the obtained image can be mirrored through an image process, or the like.

As described above, the acousto-optic imaging system 100 of the present embodiment maps the wavefront information of an ultrasonic plane wave onto the wavefront of monochromatic light by utilizing Bragg diffraction. Moreover, by removing distortion remaining in Bragg-diffracted light, the optical system (acoustic lens) for the ultrasonic wave and the optical system for the monochromatic light can be coupled together as a single double diffraction optical system. Such a configuration, despite being a small and simple optical system configuration, makes it possible to obtain an acoustic image of the imaged object as an optical image of which aberration is corrected desirably.

In the present embodiment, since the scattered wave from the imaged object 4 is received by the acoustic lens 6, the imaged object does not need to be sealed within a closed container. Therefore, it is possible to obtain, as image information, an optical image of an imaged object 4 that cannot be sealed within a closed container, or the like, such as an organ in the body.

Note that although the propagation direction of the ultrasonic wave 2 output from the ultrasonic wave source 1 and the propagation direction of the scattered wave 5 produced from the imaged object 4 are shown to be orthogonal to each other in FIG. 1, they do not have to be orthogonal to each other. Irrespective of the angle at which they cross each other, the advantageous effects of the present embodiment can be realized as long as the configuration is such that the scattered wave 5 from the imaged object 4 enters the acoustic lens 6 and propagates through the acousto-optic medium 8.

While it is assumed that the ultrasonic wave source 1 irradiates the imaged object 4 with the pulsed ultrasonic wave 2 made of a plurality of waves of the same sinusoidal waveform, the ultrasonic wave to be output may be an acoustic signal that does not have a pulsed time waveform. Moreover, the signal is not limited to an acoustic signal whose carrier wave is a sinusoidal wave, and even a wave source that produces a high-frequency elastic wave made of a repeating signal having a waveform that is not a sinusoidal wave, such as a square wave or a saw-tooth wave, can be used as the ultrasonic wave source 1.

While the present embodiment relates to the acousto-optic imaging system 100 including the ultrasonic wave source 1, the acousto-optic medium 8, the acoustic lens 6, the sound wave absorbing end 10, the monochromatic light source 11, the beam expander 12, the distortion compensation section 15, the image-forming lens 16, and the image-receiving section 17, some of these may be configured as independent devices. For example, components of the acousto-optic imaging system excluding the ultrasonic wave source 1 and the distortion compensation section 15 may be configured as an acousto-optic imaging apparatus. The ultrasonic wave source 1 may be used built in a probe of an ultrasonograph, for example. Moreover, a combination of the acoustic lens 6, the acousto-optic medium 8, the sound wave absorbing end 10, the monochromatic light source 11 and the beam expander 12 may be configured as an acousto-optic converter. Thus, the devices may be manufactured and distributed separately and independently of the system.

### Embodiment 2

Next, a second embodiment of the present invention will be described.

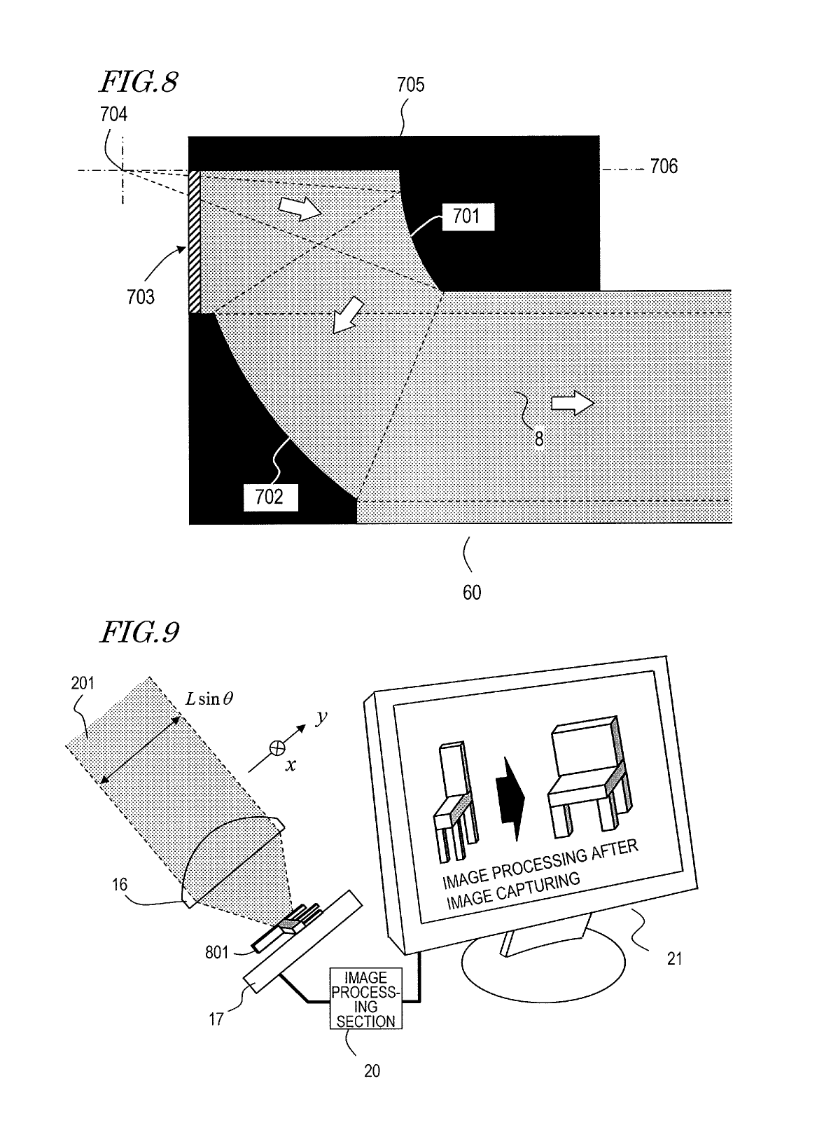

FIG. 8 is a diagram showing a configuration of an acoustic lens 60 in an acousto-optic imaging system 200 of the present embodiment. The only difference between the acousto-optic imaging system 200 of the present embodiment and the acousto-optic imaging system 100 of Embodiment 1 is the configuration of the acoustic lens. Therefore, components other than the acoustic lens 60 of the acousto-optic imaging system 200 will not be described below.

In the acousto-optic imaging system 100 of Embodiment 1, the acoustic lens 6 and the acousto-optic medium 8 are all formed by a silica nano porous material. It has been stated that the sonic speed of the silica porous material can be varied over a wide range by adjusting the condition for producing a silica nano porous material. Thus, using a silica nano porous material as the acoustic lens 6 allows for a flexible acoustic medium selection. As with ordinary optical lenses of a multi-group configuration, it is possible to configure the acoustic lens 6 capable of desirably correcting aberrations and having a wide image circle (an area on the focal plane where good image-forming characteristics are obtained). However, when a silica nano porous material and a silica porous material are attached together, it is difficult not to have an air layer sandwiched therebetween. Therefore, with only the silica porous material, it is difficult to construct the acoustic lens 6.

In the present embodiment, in order to solve the above problem, the acoustic lens 60 shown in FIG. 8 is used. FIG. 8 is a cross-sectional view of the acoustic lens 60 for a plane that includes an optical axis 706 of the acoustic lens 60 and the optical axis 13 of the plane wave light beam 14. That is, the drawing sheet of FIG. 8 is a plane that is defined by the optical axis 706 and the optical axis 13.

The acoustic lens 60 has a structure in mirror image symmetry where the drawing sheet of FIG. 8 is the plane of symmetry. The acoustic lens 60 is produced as follows. First, a rotationally symmetrical structure where the optical axis 706 is the rotational symmetry axis is divided along a plane that contains the optical axis 706 and is perpendicular to the drawing sheet of FIG. 8, and one half thereof is left remaining. Then, the remaining structure is divided along two planes that are parallel to the drawing sheet of FIG. 8 and are at an equal distance from the drawing sheet of FIG. 8. The structure sandwiched between these two planes is the three-dimensional structure of the acoustic lens 60.

As shown in FIG. 8, the acoustic lens 60 forms a reflective-type optical system. For example, an acoustic waveguide 705 made of a metal having a reflective surface is produced by a cutting process, or the like, and then a single type of a uniform silica nano porous material is sealed in the produced acoustic waveguide, thereby obtaining the acoustic lens 60 with good aberration correction.

As shown in FIG. 8, an example of a reflective-type optical system suitable for the present embodiment is a cassegrain optical system having two reflective surfaces (a primary mirror 702, which is a concave mirror, and a sub-mirror 701, which is a convex mirror). By using a Ritchey-Chretien optical system for the surface shape of the primary mirror 702 and the sub-mirror 701, it is possible to desirably correct aberrations of a cassegrain optical system when the focus is shortened. Note that in the Ritchey-Chretien optical system, an image plane curvature remains at a focal point 704, but this image plane curvature can be corrected by subjecting the interface of the silica nano porous material that is closer to the focal point (the surface provided with an antireflection film 703) to a curved surface process so that it can function as a correction lens.

As described above, by using such a reflective-type optical system as described above as the acoustic lens 60, it is possible to form the acoustic lens 60 with aberrations desirably corrected only by a single silica nano porous material without attaching a plurality of types of silica nano porous materials which are difficult to produce.

### Embodiment 3

Next, a third embodiment of the present invention will be described.

FIG. 9 is a diagram showing a configuration example of the distortion compensation section 15 in an acousto-optic imaging system of the present embodiment. The only difference between the present embodiment and Embodiments 1 and 2 is the configuration of the distortion compensation section 15. Therefore, components other than the distortion compensation section 15 will not be described below.

As shown in FIG. 3, where the diffraction angle is θ, the diffraction light 201 generated by Bragg diffraction is contracted by a factor of sine in a direction parallel to the drawing sheet of FIG. 3 (the y-axis direction). Therefore, if the diffraction light 201 is imaged by the image-forming lens 16 as it is, the image 18 is distorted, and it is not possible to obtain an image similar to the imaged object 4. In order to solve this problem, the function of the distortion compensation section 15 was to change the diffraction light 201 by a factor of 1/sin θ in the direction parallel to the drawing sheet of FIG. 3 (the y-axis direction), thereby compensating for the light beam distortion. Then, in Embodiment 1 and Embodiment 2, the distortion compensation section 15 was realized by using an anamorphic prism, which is an optical device.

However, in the present embodiment, the distortion compensation section 15 is realized by means other than optical means. As shown in FIG. 9, an image 801 of the diffraction light 201, which has been distorted through the image-forming lens 16, is captured as distorted by the image-receiving section 17, and the distortion is removed through an image process. Thus, an image similar to the imaged object 4 is realized.

As described above, by using, as the distortion compensation section 15, an apparatus configuration in which the image 801 of the diffraction light 201 is captured as distorted and the distortion of the image 801 is removed through an image process, it is possible to reduce the number of optical devices as a whole.

Note that where the diffraction angle θ is small, an image of the imaged object 4 will be significantly reduced in the x direction in the coordinate system shown in FIG. 9 on the focal plane of the image-forming lens 16, and the image resolution after the image process in the x direction will be different from that in the y direction. Therefore, in order to mitigate this problem, the distortion compensation section 15 shown in FIG. 3 and the distortion compensation section 15 shown in FIG. 9 may be used in combination.

### Embodiment 4

Next, a fourth embodiment of the present invention will be described.

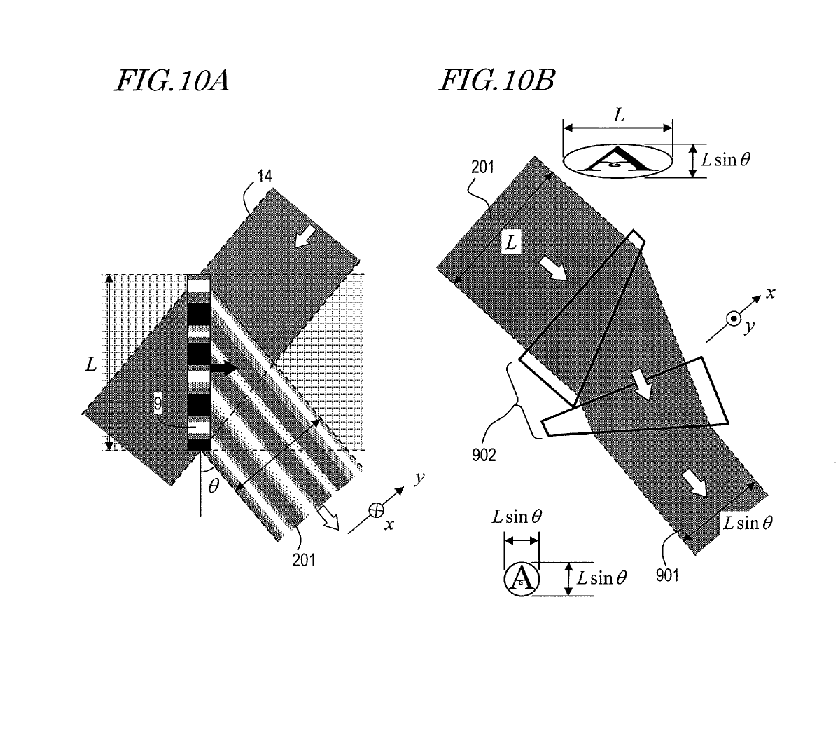

FIG. 10 is a diagram showing a configuration example of the distortion compensation section 15 in an acousto-optic imaging system of the present embodiment. The only difference between the present embodiment and Embodiments 1 to 3 is the configuration of the distortion compensation section 15. Therefore, components other than the distortion compensation section 15 will not be described below.

The distortion compensation section 15 in the present embodiment is realized by a reduction optical system 902 for changing the light beam width of the diffraction light 201 by a factor of sin θ (<1) in the x direction in the coordinate system shown in FIG. 10. Herein, θ is the diffraction angle of the diffraction light 201. Assuming that the cross-sectional shape of the sound beam of the plane wave 9 is a circular shape having a diameter of L, the cross-sectional shape of the light beam of the diffraction light 201 is an elliptical shape having a size of L in the x direction and L×sin θ in the y direction. The reduction optical system 902 changes the cross-sectional shape of the light beam of the diffraction light 201 by a factor of sine in the x direction. Thus, the cross-sectional shape of the light beam of diffraction light 901 after the distortion compensation is a circular shape having a diameter of L×sin θ. While the object of the distortion compensation section 15 was to correct the diffraction light 201 into a light beam having a diameter of L in Embodiment 1 and Embodiment 2, the present embodiment is characterized in that it is corrected to a light beam having a diameter of L×sin θ.

Herein, assume that f denotes the focal length of the acoustic lens 6, F denotes the focal length of the image-forming lens 16, λa denotes the wavelength of the plane wave 9, which is an ultrasonic wave, λo denotes the wavelength of the plane wave light beam 14, which is monochromatic light, and θ denotes the diffraction angle. Then, the image 18 of the diffraction light 901 after the distortion compensation is similar to the imaged object 4. According to Fourier optics, the ratio of similitude is (λa×f)/(λo×F)×sin θ. However, based on the relationship of Expression 1, where the diffraction light 201 is ±1^{st}-order diffraction light, the ratio of similitude is ½×(f/F). Thus, due to the advantageous effect of the reduction optical system 902, the ratio of similitude will no longer dependent on the wavelengths of the ultrasonic wave and the monochromatic light. Therefore, by setting the focal length ratio between the acoustic lens 6 and the image-forming lens 16 to be f/F=2, for example, it is possible to obtain the image 18 having the same size as the imaged object 4, thus allowing a high-resolution image to be obtained. Moreover, if f is set to be a short focus, F will also inevitably be a short focus, thereby simultaneously realizing a reduction in size of the acousto-optic imaging system. Furthermore, since the light beam of the diffraction light 901 after distortion compensation will be narrow, the size of the image-forming lens 16 will be reduced with a reduced opening size, and the image-forming lens 16 does not need to have a high surface precision.

In Embodiment 1 and Embodiment 2, the ratio of similitude of the image 18 with respect to the imaged object was (λa×f)/(λo×F). As described above in detail with reference to FIG. 6, since the ultrasonic wavelength is significantly longer than the monochromatic light wavelength, the image-forming lens 16 of a very long focal length is used in order to obtain a large image 18. This leads to an increase in the size of the acousto-optic imaging system, or it is preferred to use the image-forming lens 16 having a special optical system configuration (a cassegrain folded optical system in the example shown in FIG. 6). In the present embodiment, since the reduction optical system 902 is used as the distortion compensation section 15, it is possible to obtain a high-resolution image for a large image and to reduce the size of the system while using the image-forming lens 16 having a small opening size and a short focal length.

Note that while the reduction optical system 902 is formed by an anamorphic prism in the configuration example shown in FIG. 10, any other reduction optical system may be used as long as it is an optical system having a similar function. In the configuration example shown in FIG. 10, where the sound beam cross-sectional shape of the plane wave is a circular shape having a diameter of L, there is generated diffraction light 901 after distortion compensation whose light beam cross-sectional shape is a circular shape having a diameter of L×sin θ. The diameter of the light beam cross section of the diffraction light 901 after distortion compensation is not limited to L×sin θ, but it is possible to mitigate the increase in the focal length and the increase in the resolution of the acoustic lens 6 if correction is made so as to obtain a circular shape represented by C×L (where C<1). A configuration for realizing this means is, for example, to use a reduction optical system for the x direction in FIG. 10 and a magnifying optical system for the y direction. Then, the beam reduction ratio for the x direction and the beam magnification ratio for the y direction can be appropriately selected so that the light beam cross-sectional shape of the diffraction light 901 after distortion compensation is a circular shape having a diameter of C×L (where C<1).

Moreover, a configuration where the reduction optical system 902 of the present embodiment and the apparatus configuration of FIG. 9 (Embodiment 3) are used in combination is also useful as the distortion compensation section 15. Note however that in this case, the beam reduction ratio of the reduction optical system 901 is set so that the light beam cross-sectional shape of the diffraction light 901 after distortion compensation is an elliptical shape having a size of C×L (where C<1) in the x direction and L×sin θ in the y direction in the coordinate system shown in FIG. 10. By using such an apparatus configuration, it is possible to mitigate the problem of Embodiment 3 that the resolution of the obtained image varies depending on the direction on the focal plane of the image-forming lens 16.

### Embodiment 5

Next, a fifth embodiment of the present invention will be described.

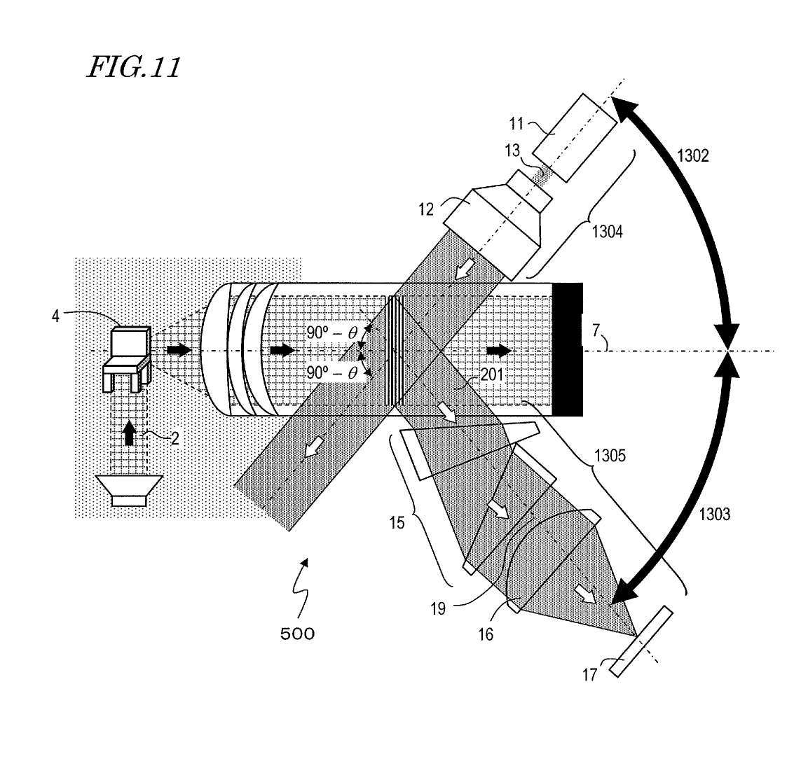

FIG. 11 is a diagram showing a schematic configuration of an acousto-optic imaging system 500 of the present embodiment. The only difference between the present embodiment and Embodiments 1 to 4 is that angle adjustment sections 1302 and 1303 are further included. Therefore, components other than the angle adjustment sections 1302 and 1303 will not be described below.

In FIG. 11, a system composed of the monochromatic light source 11 and the beam expander 12 will be referred to as a light beam generation section 1304. Moreover, a system composed of the distortion compensation section 15, the image-forming lens 16 and the image-receiving section 17 will be referred to as a diffraction light image-forming section 1305. An optical axis 19 is a straight line that passes through the light beam center of the diffraction light 201 and is parallel to the traveling direction of the diffraction light 201. As can be seen from the description of Bragg diffraction in Embodiment 1, the drawing sheet of FIG. 11 is equal to a plane determined by the optical axis 7, the optical axis 13 and the optical axis 19.

A characteristic of the acousto-optic imaging system 500 of the present embodiment is the inclusion of the angle adjustment section 1302 for adjusting the angle formed by the optical axis 13 of the light beam generation section 1304 with respect to the optical axis 7, and the angle adjustment section 1303 for adjusting the angle formed by the optical axis 19 of the diffraction light image-forming section 1305 with respect to the optical axis 7. The angle adjustment section 1302 and the angle adjustment section 1303 operate together for an angle adjustment such that the angle formed between the optical axis 7 and the optical axis 13 and the angle formed between the optical axis 7 and the optical axis 19 are always equal to each other.

As described above in Embodiment 1, the diffraction angle 90°−θ of the diffraction light 201 with respect to the optical axis 7 is determined based on the frequency of the pulsed ultrasonic wave 2 and the wavelength of the light emitted from the monochromatic light source 11. Thus, the acousto-optic imaging system 500 of the present embodiment is capable of imaging by adjusting the angles of the angle adjustment section 1302 and the angle adjustment section 1303 even if the frequency of the pulsed ultrasonic wave 2 changes.

The characteristic of the acousto-optic imaging system 500 of the present embodiment that the frequency of the pulsed ultrasonic wave 2 can be set freely has the following advantage. Being able to measure the imaged object with different ultrasonic wavelengths is equivalent to being able to have the imaging resolution variable. With this characteristic, it is possible to realize an imaging scheme in which the imaged object 4 is first coarsely observed with a low-frequency ultrasonic wave, thereafter observing the details using a high-frequency ultrasonic wave. This is advantageous in that the imaging time can be shortened.

Note that while the positions of the light beam generation section 1304 and the diffraction light image-forming section 1305 are adjusted so that the angle of incidence and the diffraction angle of the plane wave light beam are always equal to each other in the present embodiment, the two angles may be adjusted to be different angles. Only one of the angle adjustment sections 1302 and 1303 may be provided. For example, this configuration works advantageously for cases such as a case where the pulse width of the pulsed ultrasonic wave 2 is short and the primary component of the diffraction light 201 is Raman-Nath diffraction. While the angle of incidence of the plane wave light beam 14 with respect to the ultrasonic wavefront and the diffraction angle of the diffraction light 201 are always equal to each other with Bragg diffraction as described above with reference to FIG. 2B, these angles are typically not equal to each other with Raman-Nath diffraction. Thus, the apparatus configuration described above makes possible imaging using Raman-Nath diffraction light. The above configuration also enables imaging using Raman-Nath diffraction light by changing the frequency of the pulsed ultrasonic wave 2. This can also be realized by fixing the direction of the optical axis 13 at a certain direction, and providing only the angle adjustment section 1303 so as to adjust the direction of the optical axis 19 in accordance with the change in the diffraction angle when the frequency of the pulsed ultrasonic wave 2 changes.

### Embodiment 6

Next, a sixth embodiment of the present invention will be described.

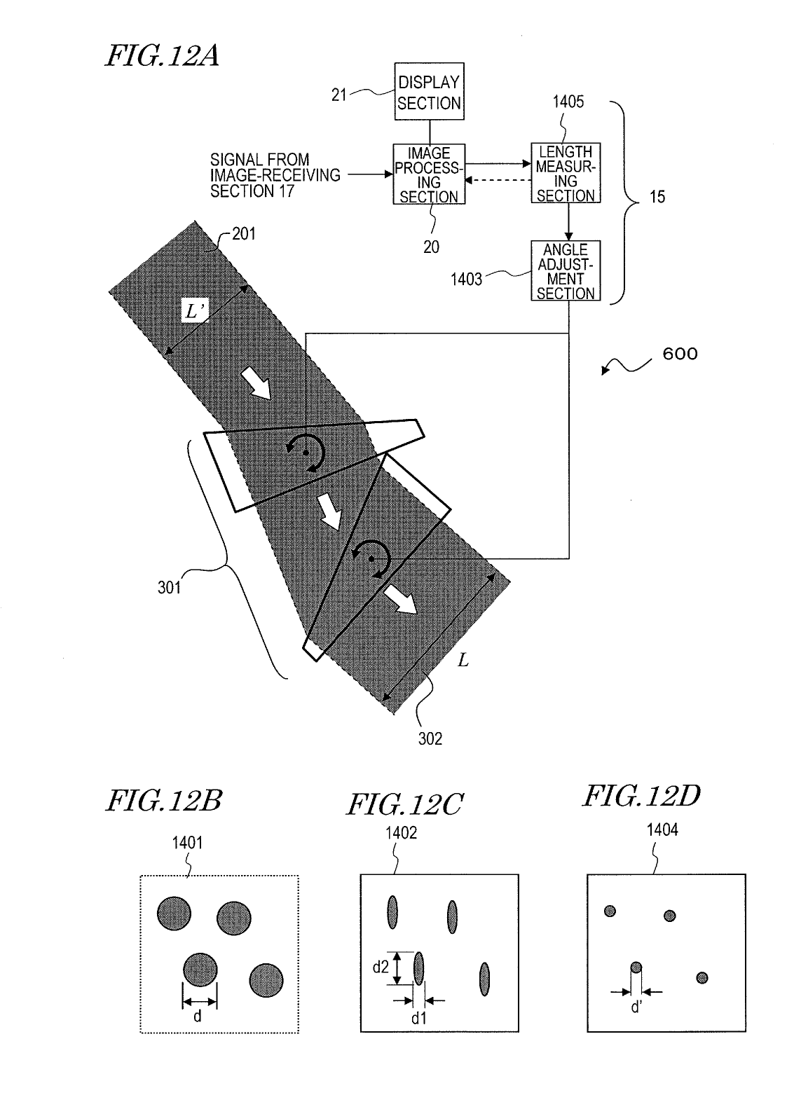

FIG. 12A generally shows a configuration of the distortion compensation section 15 of the acousto-optic imaging system 600 of the present embodiment. The present embodiment is different from the first to fifth embodiments in that the distortion compensation section 15 includes the image processing section 20, a length measuring section 1405 and an angle adjustment section 1403. Therefore, components other than the image processing section 20, the length measuring section 1405 and the angle adjustment section 1403 will not be described below.

The distortion compensation section 15 of the present embodiment corrects the distortion of the optical image or the distortion of the image generated from image information based on the image information obtained at the image-receiving section 17. Therefore, the image processing section 20 receives an electrical signal converted from an optical image by the image-receiving section 17, i.e., image information, performs a signal process suitable for image display, and displays the processed image on the display section 21. The length measuring section 1405 measures the length of an object in the image. It also outputs the measurement results to the angle adjustment section 1403 and the image processing section 20. The angle control section 1403 rotates the anamorphic prism 301 based on the received measurement results.

Next, a procedure for adjusting the distortion of the optical image by the distortion compensation section 15 of the present embodiment will be described. In the acousto-optic imaging system 600 of the present embodiment, when imaging an imaged object, a calibration sample is first imaged and the distortion of the optical image is adjusted. As shown in FIG. 12B, a calibration sample 1401 is an elastic member of which the shape and the size are known in advance is immersed in the isometric medium 3 of which the sonic speed and the acoustic impedance are known in advance. The medium 3 used in the calibration sample 1401 preferably has the same sonic speed as that of the medium 3 in which an actual imaged object 4 to be imaged is immersed. For example, where an actual imaged object 4 to be imaged is a body tissue, the medium 3 used in the calibration sample 1401 may be a wet gel, a wet urethane rubber, or the like, that has the same sonic speed as that of the body tissue. The elastic member to be immersed may be a spherical elastic member having a diameter of d, or the like, as shown in FIG. 12B. Note that in order to obtain a sharp image, the acoustic impedances of the elastic member and the medium 3 are significantly different from each other.

FIG. 12C shows an image 1402 of the calibration sample 1401 displayed on the display section 21. The length measuring section 1405 measures the dimensions of the elastic member from the image 1402. In the example of FIG. 12C, a spherical elastic member having a diameter of d is imaged as being a spheroid having a minor axis length of d1 and a major axis length of d2. The length measuring section 1405 outputs the measurement results to the angle adjustment section 1403 unless the minor axis length d1 and the major axis length d2 measured satisfy d1=d2.

The angle adjustment section 1403 rotates the angle of the anamorphic prism 301 so that d1=d2 holds based on the minor axis length d1 and the major axis length d2 received from the length measuring section. Thus, as described above with reference to FIG. 4, the angles θ1 and θ2 change, the light beam magnification ratio obtained by Expression 3 changes, and the distortion of the optical image is corrected. Thereafter, the calibration sample 1401 is imaged again, and the above procedure is repeated until d1=d2 holds. Thus, an image 1404 of which the distortion has been corrected is displayed on the display section 21 as shown in FIG. 12D.

When d1=d2 holds, the length measuring section 1405 calibrates the scale of the length measuring section 1405 so that the diameter d2 (or d1) measured by the length measuring section 1405 satisfies d=d2. Thus, in the image shown in FIG. 12D, the diameter d′ of the elastic member in the displayed image is displayed as the value of the diameter d. In this case, the scale is defined by the ratio between the diameter d2 of the spherical elastic member to be calibrated and the diameter d of the actual spherical elastic member, i.e., d/d2.

The length measuring section 1405 may be configured to use a calibrated scale to measure the length of an arbitrary portion of the displayed image. For example, the image processing section 20 may generate image data of a cursor so that a pair of movable cursors are displayed on the display section 21. The operator may move a cursor displayed on the display section 21 using a user interface such as a mouse to an arbitrary place, and the length measuring section 1405 may calculate the distance between the pair of cursors using the calibrated scale. Thus, on the obtained image, it is possible to measure the size of the imaged object with a high precision irrespective of variations of the measurement environment.

Thus, with the acousto-optic imaging system of the present embodiment, it is possible to correct the distortion of the optical image with a high precision accommodating measurement environments. For example, where the imaged object is a body tissue of a subject, a change in the body temperature of the subject influences the size of the real image 18 and a change in the temperature of the acousto-optic medium 8 influences the distortion of the image. In environments where such a subject is imaged, it may be difficult to adjust the body temperature of the subject or the temperature of the place where the imaging is done. According to the present embodiment, it is possible, without adjusting the two temperatures, to correct the distortion of the obtained optical image by imaging the calibration sample. Therefore, it is possible to display, with a correct shape, tumor, polyp, calculus, and the like, inside the body of the subject. It is also possible to measure the accurate size thereof.

Note that elastic members to be immersed in the calibration sample 1401 do not have to be spheres of the same size and the number thereof does not need to be large. They do not have to be spherical elastic members as long as they are elastic members of known size and shape. While the angle adjustment section 1403 adjusts the angle of the anamorphic prism 301 based on the measurement results of the length measuring section 1405 in the present embodiment, the image distortion correction may be done through an image process after imaging. In such a case, the image processing section may receive the measurement results of the length measuring section 1405, and adjust the lengths of the obtained image 1402 in the x direction and the y direction (FIG. 9) so that d1=d2 holds.

An acousto-optic imaging system disclosed in the present application is capable of obtaining an ultrasonic image as an optical image and is therefore useful as a probe for an ultrasonograph, etc. It can also observe, as an optical image, ultrasonic waves radiated from a vibrating object, and it can therefore also be used in applications such as non-destructive vibration measuring apparatuses.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. An acousto-optic imaging system comprising:
an ultrasonic wave source configured to irradiate an imaged object with an ultrasonic wave made of an acoustic signal having a time waveform which is repeated at intervals of a predetermined amount of time;
an acoustic lens arranged so as to receive a scattered wave of the ultrasonic wave, with which the imaged object has been irradiated, and convert the scattered wave to a plane wave;
a light-transmitting acoustic medium provided in an area on an opposite side of the imaged object with respect to the acoustic lens, which area includes an optical axis of the acoustic lens therein;
a light source configured to output a monochromatic light plane wave, the light source being arranged so that a traveling direction of the monochromatic light plane wave and the optical axis of the acoustic lens cross each other at an angle other than 90 degrees and 180 degrees;
an image-forming lens arranged so as to condense diffraction light of the monochromatic light plane wave which is produced in the light-transmitting acoustic medium;
an image-receiving section configured to obtain, as image information, an optical image formed by the image-forming lens; and
a distortion compensation section configured to correct a distortion of the optical image or a distortion of an image generated from the image information.

2. The acousto-optic imaging system of claim 1, wherein the ultrasonic wave is an acoustic signal whose carrier wave is a sinusoidal wave.

3. The acousto-optic imaging system of claim 2, wherein the ultrasonic wave has a pulsed time waveform of which a duration is greater than or equal to an inverse of a carrier wave frequency.

4. The acousto-optic imaging system of claim 1, wherein the acoustic lens includes a focusing mechanism.

5. The acousto-optic imaging system of claim 1, wherein the acoustic lens is a refractive acoustic lens.

6. The acousto-optic imaging system of claim 5, wherein the acoustic lens is made of a silica nano porous material.

7. The acousto-optic imaging system of claim 1, wherein the acoustic lens is a reflective acoustic lens.

8. The acousto-optic imaging system of claim 7, wherein the acoustic lens is a cassegrain acoustic lens.

9. The acousto-optic imaging system of claim 1, wherein the light-transmitting acoustic medium is a silica nano porous material.

10. The acousto-optic imaging system of claim 1, wherein the distortion compensation section includes an optical system for magnifying or reducing a cross-sectional area of a light beam of diffraction light of the monochromatic light plane wave which is produced in the light-transmitting acoustic medium, and corrects a distortion of the optical image by means of the optical system.

11. The acousto-optic imaging system of claim 10, wherein the optical system includes an anamorphic prism.

12. The acousto-optic imaging system of claim 10, wherein the optical system in the distortion compensation section is arranged between the light-transmitting acoustic medium and the image-forming lens.

13. The acousto-optic imaging system of claim 1, wherein the distortion compensation section corrects, through an image process, a distortion of an image generated from the image information obtained by the image-receiving section.

14. The acousto-optic imaging system of claim 1, further comprising an angle adjustment configured to adjust a position of the light source so that an angle formed by a traveling direction of the monochromatic light plane wave output from the light source with respect to the optical axis of the acoustic lens and an angle formed by a traveling direction of diffraction light of the monochromatic light plane wave with respect to the optical axis of the acoustic lens are equal to each other.

15. The acousto-optic imaging system of claim 10, wherein a distortion of the optical image or a distortion of an image generated from the image information is corrected based on the image information.

16. An acousto-optic imaging apparatus comprising:
an acoustic lens arranged so as to receive a scattered wave of an ultrasonic wave, with which an imaged object has been irradiated;
a light-transmitting acoustic medium provided in an area on an opposite side of the imaged object with respect to the acoustic lens, which area includes an optical axis of the acoustic lens therein;
a light source for outputting a monochromatic light plane wave, the light source being arranged so that a traveling direction of the monochromatic light plane wave and the optical axis of the acoustic lens cross each other at an angle other than 90 degrees and 180 degrees;
an image-forming lens arranged so as to condense diffraction light of the monochromatic light plane wave which is produced in the light-transmitting acoustic medium; and
an image-receiving section configured to obtain, as image information, an optical image formed by the image-forming lens.
